(19) United States
(12) Patent Application Publication
(10) Pub. No.: US 2016/0203138 A1
(43) Pub. Date: Jul. 14, 2016

(54) SYSTEMS AND METHODS FOR GENERATING ANALYTICS RELATING TO ENTITIES

(71) Applicant: Jonathan Feldschuh, New York, NY (US)

(72) Inventor: Jonathan Feldschuh, New York, NY (US)

(21) Appl. No.: 14/593,989

(22) Filed: Jan. 9, 2015

(51) Int. Cl. G06F 17/30

(52) U.S. Cl. CPC G06F 17/3053; G06F 17/30554; G06F 17/30864; G06F 17/30598

(57) ABSTRACT

The invention involves systems and methods for generating a unique set of analytics that are dependent on a set of user preferences and a database generated from one or more data sources. The analytics relate to entities of interest to consumers such as restaurants, hotels, or other goods and services. The analytics are provided to consumers over a network such as the internet to aid them in determining which entities of interest to patronize or consume.

### BACKGROUND OF THE INVENTION

1. Field of the Invention (Technical Field)

Embodiments of the present invention relate to systems and methods for calculating analytics that change based on changing user preferences. The analytics relate to entities that a user might be interested in searching for in order to patronize.

2. Description of Related Art

These days, users have an array of options to search for information on the internet. This includes options to search for information about entities that users are considering visiting, such as restaurants or hotels, or buying such as products or services.

Conventional search options produce a wide variety of results depending on factors including the user query, the search algorithms, the type of data being searched, and the manner in which the data is stored. Search engines such as Google® and Bing® allow users to search the web based on a set of words or terms and primarily return results in the form of hyperlinks to webpages. More recently they are devoting a section of the search results page to general information about entities responsive to a user query. For example, if a user searches for a particular restaurant, the search engine might return results in the form of webpages related to that restaurant as well as a separate section with factual attributes such as the restaurant's phone number and address. The search results may also include information such as user or professional ratings, perhaps in the form of a star rating or points system, but these values remain constant regardless of the query terms entered by the user. If the user enters “local pizza shops” or “Joe's Pizza”, both searches could produce Joe's Pizza as a result and the attributes displayed for Joe's Pizza including the ratings will be identical despite the difference in search terms.

Aside from search engines, users can search for information on websites dedicated specifically to providing information about a particular type of entity that the user is interested in. For example, sites such as yelp.com, or zagat.com enable users to search for restaurants in databases dedicated to storing accumulated information about restaurants. These sites typically allow the user to submit a set of search criteria along with or in lieu of word searches, and they produce a list of restaurants using a standard sort and filter type search of their database. Here as well, regardless of differences in the user's search criteria, the same information about entities in the search results is provided regardless of the specifics of the user query. Although some information may change over time, such as an average of user ratings of a restaurant, that same average will appear in the results of search at a given time regardless of differences in the search criteria.

It would be preferable to provide users with information that differs based on user search criteria such as ratings or analytics that are calculated values from in part the user search criteria. It would also be preferable if those ratings or analytics were calculated in part based on a large set of data obtained from multiple data sources to provide the most informed result possible and generate unique, on-the-fly analytics as results. In particular, it would be preferable to provide analytics that take into account information about the cost of different entities.

### INCORPORATION BY REFERENCE

All publications, patents and patent applications mentioned in this specification, if any, are herein incorporated by reference to the same extent as if each such individual publication, patent, or patent application were specifically and individually indicated to be incorporated by reference. To the extent that any inconsistency or conflict may exist between information disclosed in this patent and information disclosed in any publications, patents, or patent applications that are incorporated by reference in this patent, the information disclosed in this patent will take precedence and prevail.

### BRIEF SUMMARY OF EMBODIMENTS OF THE PRESENT INVENTION

Various example embodiments describe systems, methods, and computer readable mediums for facilitating the calculations of analytics.

One embodiment provides a system for executing software to generate analytics, which comprises a processor, a computer readable memory coupled to the processor, a network interface coupled to the processor, and software stored in the computer readable memory and executable by the processor.

That embodiment and embodiments for a computer implemented, method of generating analytics and for a computer readable medium for executing computer software all include software that is capable of identifying one or more data sources with information about entities, obtaining and storing in a database the information about the entities from the data sources, receiving and storing categorizations of attributes in the database, calculating and storing in the database a cost in dollars for each entity, receiving and storing in the database an identification of some or all attributes as predictor variables, calculating and storing in the database dollar cost estimates for the predictor variables, generating and storing in the database default weights, receiving values for at least one user preference, filtering the database for entities with attributes matching values for at least one user preference, translating default weights and values for at least one user preference into dollar cost estimate weights, calculating Raw Value Delivered, and sending a list of entities with at least one analytic for each entity to users.

Those embodiments may further include software that is capable of receiving an identification of quality values for each dollar cost estimate and storing the quality values for each dollar cost estimate in the database, calculating and storing in the database reliability values for each dollar cost estimate, receiving an identification of quality values for each record in the database and storing the quality values for each record in the database, and receiving an identification. Those embodiments may further include software capable of calculating Raw Grade. Those embodiments may further include software capable of calculating Net Value. Those embodiments may further include software capable of calculating Cost-Aware Grade. Those embodiments may further include software capable of calculating Reliability Grade. Those embodiments may further include software capable of calculating Search Grade. Those embodiments may further include software capable of calculating Style Grade. Those embodiments may further include software capable of calculating the Suitability Grade. Those embodiments may further include software capable of calculating Distance. Those embodiments may further include software capable of calculating the Priority Grade.

### BRIEF DESCRIPTION OF THE SEVERAL VIEWS OF THE DRAWINGS

The drawings, which are incorporated herein, illustrate one or more embodiments of the present invention, thus helping to better explain one or more aspects of the one or more embodiments. As such, the drawings are not to be construed as limiting any particular aspect of any embodiment of the invention. In the drawings:

FIG. 1 shows an exemplary system architecture according to one embodiment.

FIG. 2 shows a flowchart reflecting the process of providing a user with prioritized entities and their analytics.

FIG. 3 shows a flowchart reflecting the process of generating a database by filling it with data necessary to carry out steps from FIG. 2.

FIG. 4 shows a data table with a portion of data that a database might contain after step 303 according to one embodiment.

FIG. 5 shows a process of the calculating and storing default weights according to one embodiment.

FIG. 6 shows a flowchart for the individual modeling process and the selection of dollar cost estimates to be used in subsequent calculations of the analytics according to one embodiment.

FIG. 7 shows a table that exemplifies how the goodness-of-fit is applied to the modeled predictor variable data according to one embodiment.

FIG. 8 shows an exemplary table from a database with columns for the dollar cost estimates along with columns for the quality and reliability values.

FIG. 9 shows an exemplary form that provides users with a search mechanism for entities of interest using inputs for a novel set of user preferences that relate to information collected from one or more data sources.

FIG. 10 shows an exemplary table of results returned to the user following receipt by data processing system of user preferences selected by the user according to one embodiment.

FIG. 11 shows the “mood” drop down menu extended such that all the possible options available to the user are visible according to one embodiment.

FIG. 12a shows an exemplary table of categorizations of received and stored and default weights generated and stored as they are applied to predictor variables stored in a database according to one embodiment.

FIG. 12b shows another exemplary table of categorizations of attributes received and stored in a database according to one embodiment.

FIG. 12c shows yet another exemplary table of categorizations of attributes received and stored in a database according to one embodiment.

FIG. 13 shows a table of default values for user preferences that is added to a database prior to receipt of user preferences according to one embodiment.

FIG. 14 shows a process of generating analytics in response to a receipt of user preferences according to one embodiment.

FIG. 15 shows a flowchart for the process of translating user preferences into dollar cost estimate weights for different dollar cost estimates according to one embodiment.

FIG. 16 through FIG. 22 each show exemplary webpages useful to explain how the selection of values for particular user preferences impact the results sent the user.

### DETAILED DESCRIPTION OF THE INVENTION

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims. Most of the examples and descriptions in this disclosure pertain to food establishments as the entities. The systems and methods described herein could also apply to other kinds of establishments such as hotels, bars, attractions, etc. as the entities, using similar information about location, cost, and ratings of those establishments. The systems and methods described herein could also apply to products and services for sale, such as retail items or professional services, using information about cost and ratings for the goods and services, and location information for the stores offering the goods or services.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured. Furthermore, while the exemplary embodiments illustrated herein show various components of the system collocated, it is to be appreciated that the various components of the system can be located at distant portions of a distributed network, such as the Internet, LAN, WAN or within a dedicated secured, unsecured, and/or encrypted system.

Thus, it should be appreciated that the components of the system can be combined into one or more devices, or split between devices. As will be appreciated from the following description, and for reasons of computational efficiency, the components of the system can be arranged at any location within a distributed network without affecting the operation thereof.

Furthermore, it should be appreciated that the various links and networks, including any communications channel(s) connecting the elements can be wired or wireless links or any combination thereof, or any other known or later developed elements(s) capable of supplying and/or communicating data to and from the connected elements. The term module as used herein can refer to any known or later developed hardware, software, firmware, or combination thereof, which is capable of performing the functionality associated with that element.

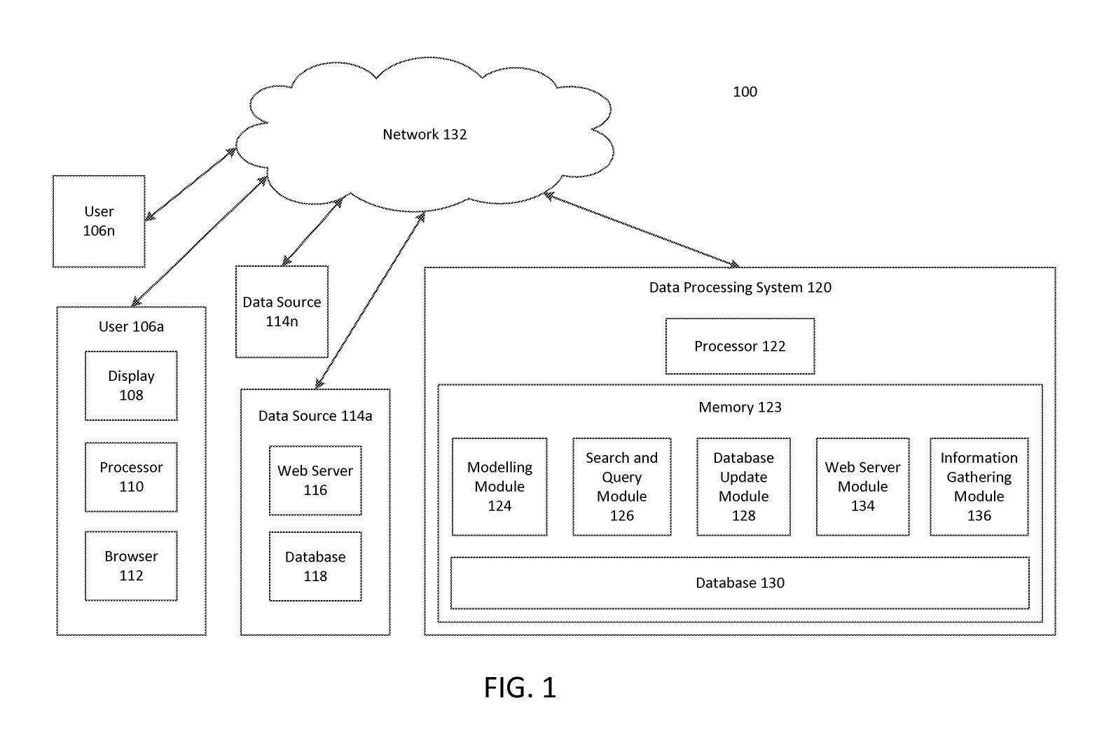

FIG. 1 shows an exemplary system architecture 100 according to one embodiment.

FIG. 1 includes a plurality of data users 106a . . . 106n, sources 114a . . . 114n, a data processing system 120, and a network 132. Data processing system 120 or its components can be any appropriate data processing system including but not limited to a personal computer, a wired networked computer, a wireless network computer, a server, a mobile phone or device containing a mobile phone, a hand-held device, a thin client device, or some combination of the above, and so on. As would be apparent to anyone of ordinary skill in the art, each of these devices has a processor, computer readable memory coupled to the processor, a network interface coupled to the processor, and software stored in the computer readable memory and executable by the processor. Data processing system 120 may include any number of known input and output devices such as a monitor, keyboard, mouse, etc. Data processing system 120 may be configured to interact with data sources 116 through network 132. Network 132 can be any network that allows communication between one or more of the data sources 116, data processing system 120, and user 106. For example, network 132 can be but is not limited to the Internet, a LAN, and WAN, a wired network, a wireless network, a mobile phone network, a network transmitting text messages, or some combination of the above.

In one embodiment, data processing system 120 includes a processor 122 and memory 123. Stored in memory and processed by the processor are a modeling module 124, an information gathering module 136, a search and query module 126, a database update module 128, web server module 134, and a database 130. In one implementation, the modeling module 1222s responsible for performing calculations on data retrieved by search and query module 126 and stored in a database 130 by database update module 128 including modeling of predictor variables versus calculated dollar costs, generating predictions based on those models, and passing results to database update module 128. Each of these functions is described in detail below. In some implementations, modeling module 124 uses programming languages such as R and Python and/or software such as SAS or MATLAB to perform these functions, but there are many other combinations of programs, scripts and API's that could be used.

In one implementation, the information gathering module 136 is responsible for obtaining information from data sources and passing the information to the database update module 128. In this implementation, information gathering module 136 may communicate with and gather information from data sources 114 using a network connection to network 132 between data processing system 120 and data sources 114. The process of obtaining the data could take various forms in different embodiments. In different implementation, information could be entered into a database 130 by information gathering module 136 manually, scanned from printed form, taken directly in whole or in part from an existing database, gathered from an API (application programming interface), or by analyzing data sources 114 that are websites. In some implementations, the information gathering module 136 might use programming languages like R, Python, C++, Perl, etc. to gather information from such sources.

In one implementation, the search and query module 126, receiving information about user preferences from web server module 134 (e.g. desired features, cost limits, location), searches a database 130 and returns information to either modeling module 124 for calculations of analytics or to web server module 134 when no calculation are necessary, such as static information about entities (e.g. names, locations, websites). As such, search and query module 126 may communicate with and gather information from a database 130 and/or data sources 114 using a network connection over network 132 between data processing system 120 and data sources 114. In different implementations, the search and query module 126 could be use programming languages and tools such as python, C++, MySql, etc.

In one implementation, the database update module 128 is responsible for updating a database 130 periodically as is also described in more detail below. In some implementations the database update module uses MySql to manage a database, but other programs are available to perform the necessary functions described herein. In different implementations, a database 130 contains structured data, each entry having one or more data attributes (such as name, address, status, etc), or unstructured data such as emails or articles. In different embodiments, a database 130 can be a relational database such as SQL or Oracle or a non-relational or object oriented database such as NoSQL or MongoDB database but other types of databases could be used to store similar data.

The web service module 134 can take the form of an interactive website operating in a web browser. In different implementations, a website is programmed using programming languages and protocols such as HTML5, javascript, CSS, Ruby on Rails, etc. In different implementations, the web service module 134 is a dedicated mobile application operating on a device, using the iOS, Android, Windows phone, etc. operating systems. In other implementation, the web service module 134 is in the form of software, programmed in a wide variety of languages, on a stand-alone computer or kiosk. In one embodiment, web server module 134 is any app or application configured to communicate over network 132, for example by accepting http or ftp protocol requests from user 106 and generating webpages, documents, or other information and sending them back to user 106 using the same or similar protocols. In one implementation, data processing system 120 hosts a website or web service generated by web server module 134 over network 132. In different implementations, the information returned by the web service module 134 is a list, map, table, etc. In one implementation, the web service module 134 can update the returned information to the user 106, in response to changes in the specified user preferences.

Modeling module 124, search and query module 126, database update module 128, web server module 134, information gathering module 136, and a database 130 are all shown in FIG. 1 as being in a single memory 123, although, in different embodiments, a large collection of data may be stored in many ways, including but not limited to distributed data processing systems, cooperating data processing systems, network data processing systems, cloud storage and so on.

It will be understood and appreciated by those of ordinary skill in the art that the computing system architecture 100 shown in FIG. 1 is merely an example of one suitable computing system and is not intended to suggest any limitation as to the scope of the use or functionality of the present invention. Neither should the computing system architecture 100 be interpreted as having any dependency or requirement related to any single component/module or combination of component/modules illustrated therein. It will be appreciated by one skilled in the art that the named modules 124, 126, 128, 134, and 136 in data processing system 120 could be formed in any combination with different naming conventions, and the programming and the data processing functions described herein as being part of a specific module 124, 126, 128, 134, and 136 could be part of any named module using any type of programming language or software package functioning at various levels of abstraction to perform the same functions as modules 124, 126, 128, 134, and 136 in different embodiments of the invention. Modules 124, 126, 128, 134, and 136 are disclosed to assist the reader in understanding that particular data processing functions are often performed using distinct software or programming languages within system memory 123, and can take many different forms in many different embodiments of the invention. As such, modules 124, 126, 128, 134, and 136 should not be considered to limit the invention as claimed even where aspects of embodiments of this invention are described as being implemented by a specific software modules 124, 126, 128, 134, and 136.

The data sources 114 can be a database, web service, website, server, or any other information resource. In one embodiment, data sources 114 have, but are not limited to, web servers 116 interacting with a database 118 and hosting websites for interaction with data processing system 120. The data resource 114 can be internal to, or external to the data processing system 120. In one implementation, data sources 114 may interact with data processing system 120 that accept user queries via network 132 with information pertaining to entities such as, for example, restaurants or hotels and return webpages based on queries and retrieval of information from a database 118. Examples of such data sources 114, are websites Zagats.com and Yelp.com. Data gathered from data sources may be structured or unstructured.

User 106 can be any type of computer including, but not limited to, a desktop, laptop, mobile phone or server. In one embodiment, user 106 includes a display 108, processor 110 and browser 112. Browser 112 can be any type of application configured to communicate over a network, for example by http or ftp protocol, and displaying on display 108 web pages, documents, or other information. Example browsers 112 include Internet Explorer®, Chrome®, Safari®, and Firefox®. In one embodiment, browser 112 could part website or web service hosted on data processing system 120 specifically designed to communicate with an app or application on a personal computer or mobile device over network 132 to provide and display data such as that described in this patent.

The following definitions are meant to create uniformity and aid the reader in understanding the invention. The reader should understand, however, that the definitions provided below will be enhanced based on usage of the terms in the disclosure including their underlying equations and processes in the various embodiments discussed herein.

As used herein, “dollar cost” is a cost expressed in dollars relating to entities as obtained directly from a data source 114 and stored in a database 130 without modification.

“Calculated dollar cost” is a cost that is calculated based only on dollar costs obtained from one or more data sources 114. In one embodiment, calculated dollar costs are calculated as a weighted average of the available dollar costs. In another embodiment, calculated dollar cost might be calculated non-linearly. In the event that only a single set of dollar costs corresponding to a set of entities was obtained from only a single data source 114, then the calculated dollar cost would, in one embodiment, be set as equal to that dollar cost for each entity in that set.

A “predictor variable” is an attribute of an entity in a database that is not a dollar cost but that can be used to make predictions of cost based on statistical modeling methods using, as the independent variable, the values of that attribute for a set of entities with, as the dependent variable, the associated dollar costs for that set of entities such as, for example, calculated dollar cost or any other form of adjusted dollar cost deemed useful. Examples of predictor variables are ratings of food quality for restaurants or locations of hotels.

“Joint modeling” refers to the practice of creating a statistical model using more than one independent variable to predict a single dependent variable.

“Individual modeling” refers to the practice of creating a statistical model using exactly one independent variable to predict a single dependent variable.

A “dollar cost estimate” is a prediction of cost expressed in dollars that is generated from individual or joint models using, as the independent variables, one or more predictor variables for a set of entities with, as the dependent variable, the associated costs expressed in dollars for that set of entities, such as, for example, dollar costs or calculated dollar costs.

“Analytics” are numerical values for individual entities each calculated based on different user preferences and different data in a database 130. Analytics are provided to the user 106 in response to receipt of user preferences along with an ordered list of the entities in the form of search results. Embodiments of this invention involve the calculation of eleven different analytics, which are termed for purposes of explaining the various embodiments of the invention as Raw Value Delivered, Raw Grade, Net Value, Cost-Aware Grade, Reliability Grade, Search Grade, Style Grade, Suitability Grade, Distance, and Priority Grade.

“Grades” are analytics (identified by the term “Grade” in the name of the analytic) that have been adjusted to fit within some pre-determined scale that is understandable to the user, for example a numerical grade on a scale of 0 (worst) to 100 (best). A function Grade(x) as appearing in equations herein indicates some function whose output is constrained to the desired scale. The function Grade(x) may be the same or different in different equations.

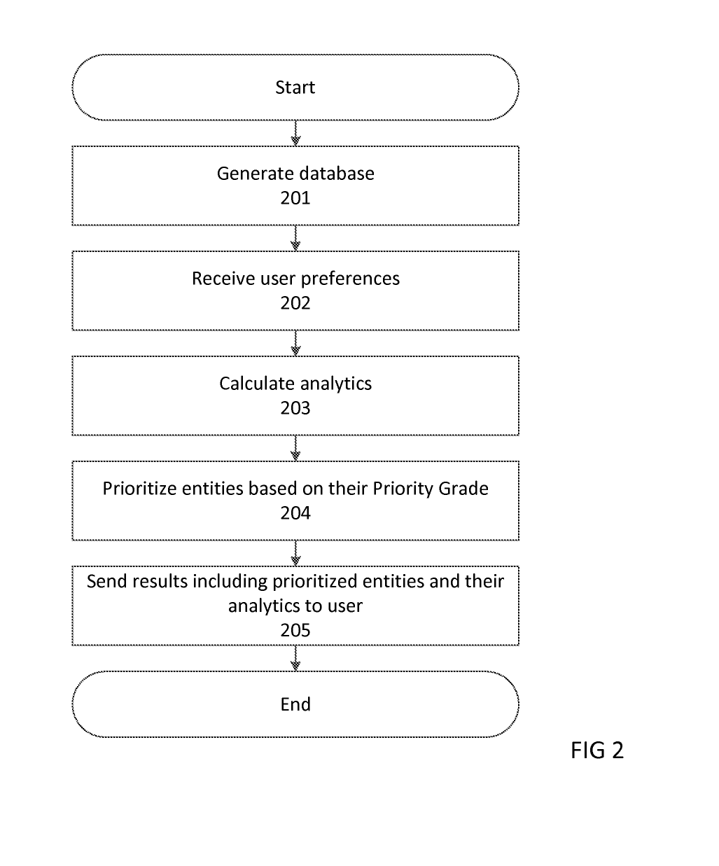

FIG. 2 shows a flowchart reflecting the process of providing a user 106 with prioritized entities and their analytics. In a this implementation, the steps of the flowchart are carried out at least in part on server data processing system 120 by modeling module 124, search and query module 126, database update module 128, web server module 134, information gathering module 136, and a database 130. As a non-limiting example of how this process might be implemented from the user's 106 perspective is as follows. Via a form in a webpage, app, or application provided by data processing system 120, user 106 inputs preferences (hereinafter “user preferences”) for a search of a specific type of entities, such as restaurants and hotels, that user 106 might be interested in. The user 106 submits the user preferences to data processing system 120 via network 132. Upon submission, the user preferences selected by user 106 using the interface provided inform data processing system 120 as to both the characteristics of the entities that the user 106 desires and to the specific sets of data in the database 130 that should be used to generate the analytics. Data processing system 120 then uses them for querying the database 130 and for performing calculations on and generating results from the data in the database 130. Upon doing so, user 106 is provided with a prioritized list of entities and a set of unique analytics for each entity. This process, thereby, provides the user 106 with a unique and novel means of selecting a particular entity.

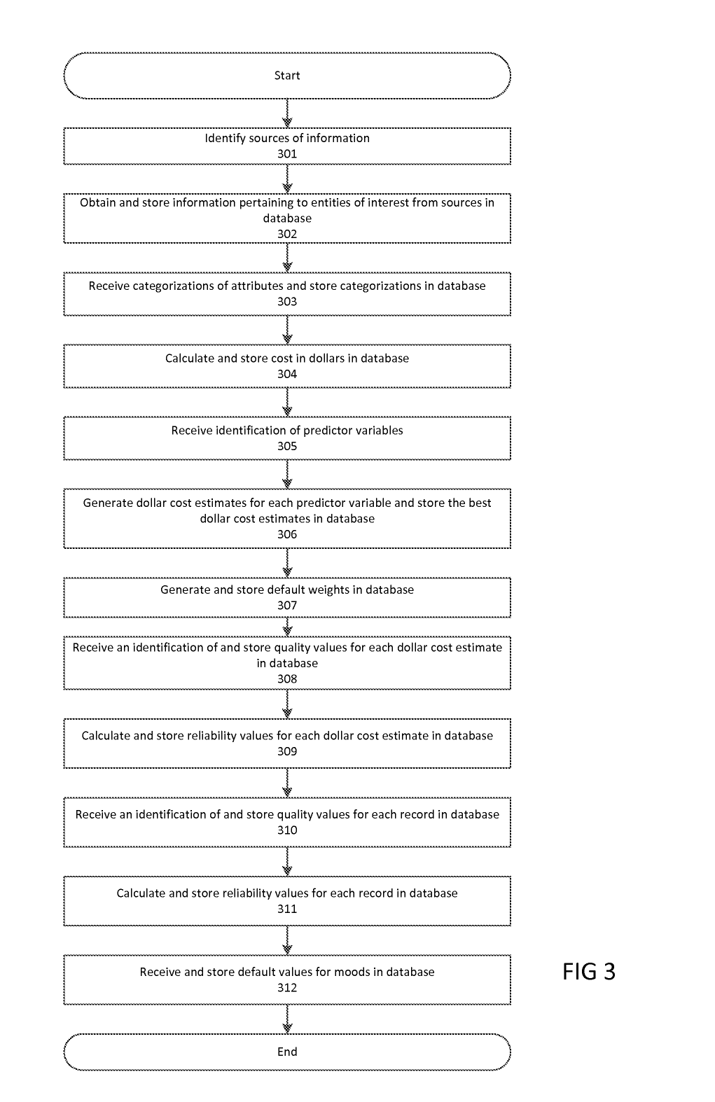

In step 201, a database 130 is generated with information that will be used to calculate the analytics and prioritize the entities based on user preferences. This step in the process uses database update module 128 and information gathering module 136 along with the database 130 in data processing system 120. Further details regarding step 201 will be provided with reference to the embodiments of FIG. 3.

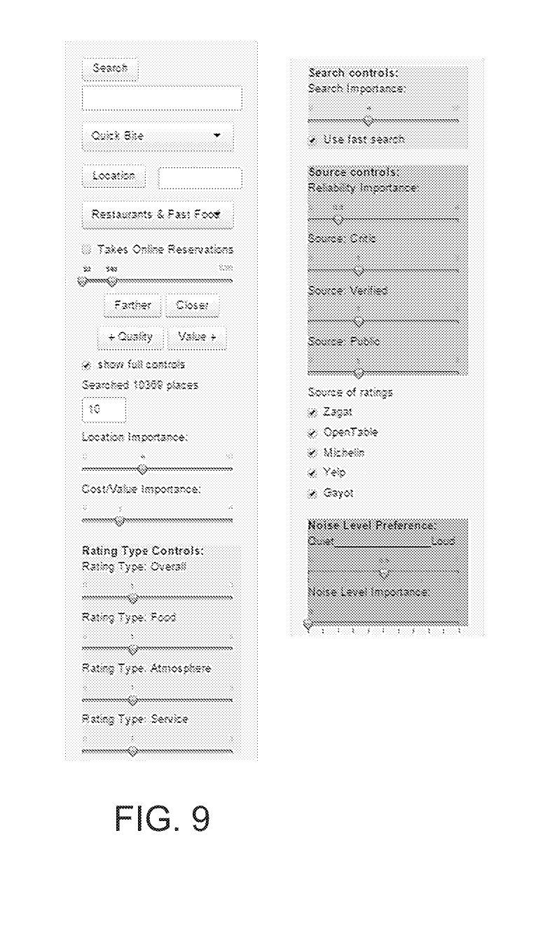

In step 202, web server module 134 receives user preferences from user 106. One embodiment of a form with a set of inputs for user preferences is shown in the embodiments of FIG. 9. In different embodiments, the form of FIG. 9 could be sent to user 106 for use by a webpage, a standalone app, or an application.

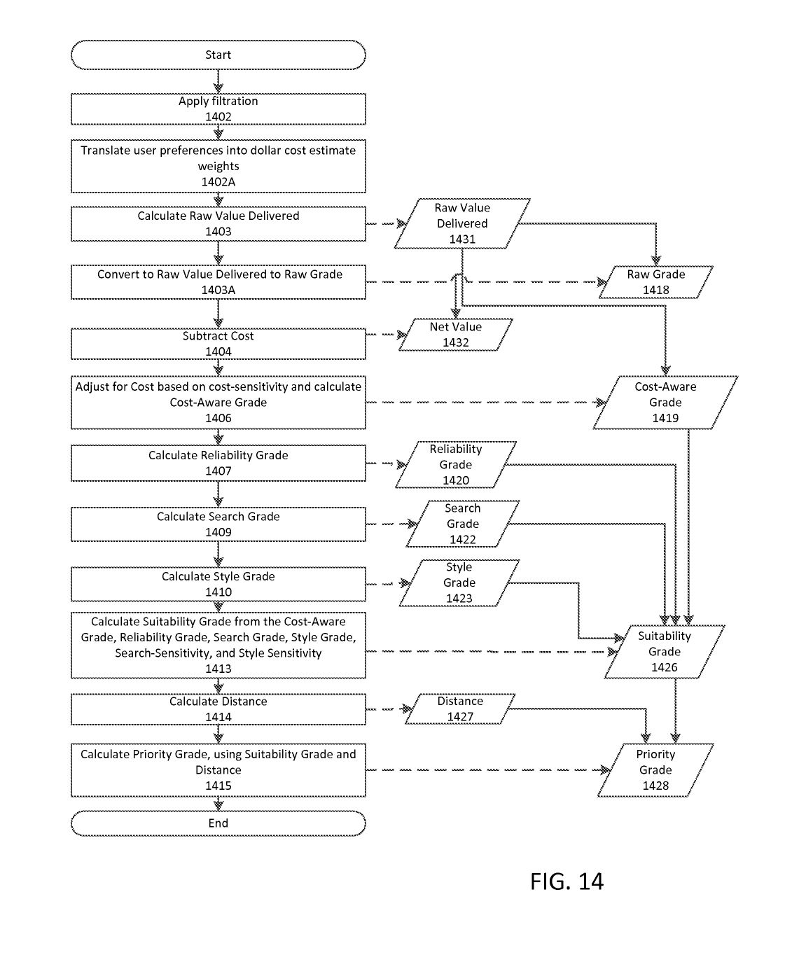

In step 203, modeling module 122 calculates the analytics for entities based on user preferences and specific data retrieved from the database 130 by search and query module 126. Further details regarding step 203 will be provided with reference to the embodiment of FIG. 14.

In step 204, modeling module orders the entities based on the Priority Grade, which is the final analytic calculated in step 203. Essentially, the entities are ordered from the highest Priority Grade to the lowest Priority Grade, but this could be reversed, in some embodiments, by convention or by user preferences for sorting the entities in reverse order.

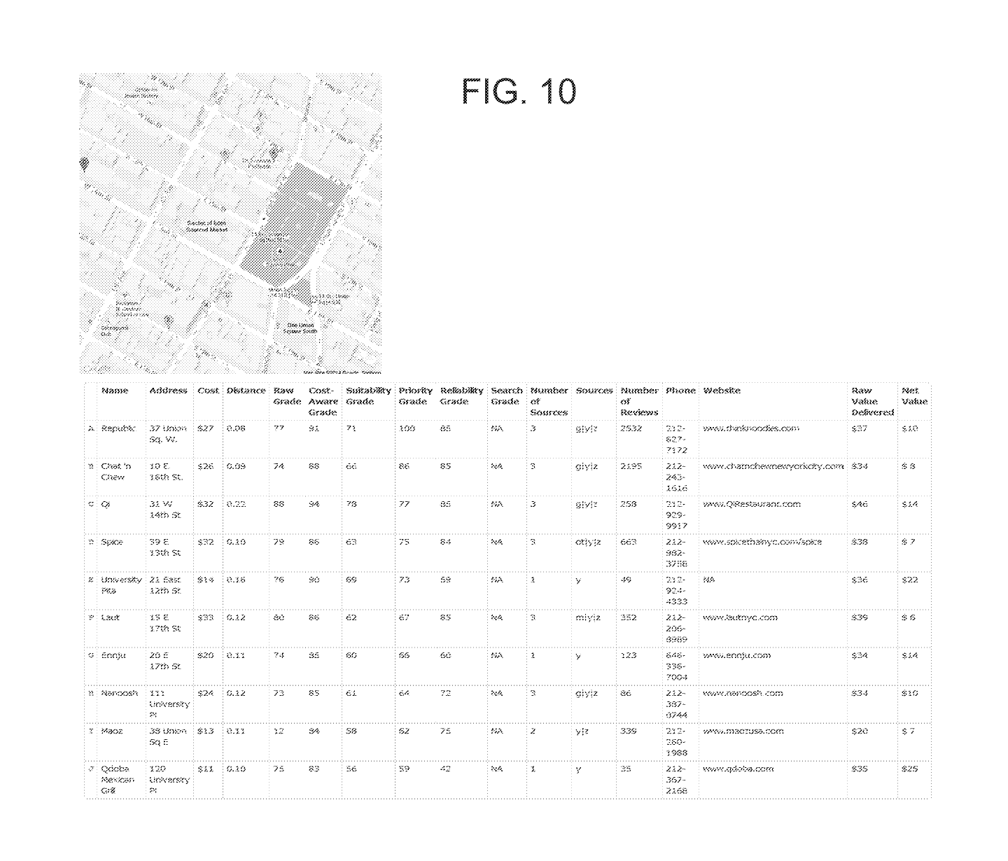

In step 205, the web server module 134 sends the results of step 203 and step 204 including the entities arranged by priority and their analytics to user 106. One embodiment of a table of results including analytics is provided in FIG. 10. In different embodiments, the table of FIG. 10 could be sent to user 106 for use by a webpage, a standalone app, or an application.

FIG. 3 shows a flowchart reflecting the process of generating a database 130 by filling it with data necessary to carry out steps 203 and 204 from FIG. 2. In this implementation, the steps of the flowchart are carried out at least in part on server data processing system 120 by modeling module 124, search and query module 126, database update module 128, and information gathering module 136 along with the database 130.

The process begins in step 301 with information gathering module 136 identifying data sources 114 that contain information pertaining to entities of a particular type, e.g., restaurants or hotels. In one implementation, information gathering module 136 may be programmed to identify data sources 114 with information of interest by performing searches on search engines for websites with pertinent information relating to a type of entities. In one implementation, information gathering module 126 identifies data source 114 by, in part, following hyperlinks programmed into information gathering module 136. In another implementation, information gathering module 136 identifies data source 114 by in part following hyperlinks programmed into information gathering module 126 and then performs searches for other sites containing information about the same entities as those available in the first set of data sources 114. In still another implementation, information gathering module 136 may be programmed to search for information matching certain entities and then identify data sources 114 with information for all entities on any sites it locates.

In step 302, information available on data sources 114 pertaining to one or more entities of interest is obtained by information gathering module 126 and stored in the database 130 by database update module 128. In one implementation, different types of information gathered from data sources 114 are stored in the database 130 as distinct attributes forming single records for each entity that appears in at least one of data sources 114. If, for example, three websites each provide dollar costs for the same restaurant, each dollar cost would be stored as the value of a distinct attribute for each of the three source websites. The same would be true for every other attribute obtained from the websites. The process of obtaining the data could take different forms in different implementations. Information could be entered into the database manually, scanned from printed form, taken directly in whole or in part from an existing database, gathered from an API, or gathered by analysis of webpages. In one implementation, information gathering module 126 obtains data through network 132 by analyzing data sources 114 that are websites and retrieving all available data about the entities of interest. In one implementation, information gathering module obtains all available information about the entities of interest from data sources 114. In another implementation, information gathering module 126 obtains data through network 132 by analyzing data sources 114 and retrieving predefined types of information about entities of interest including at least the names of entities, their dollar costs, their locations, predictor variables, textual reviews of the entities, the source of the reviews, for example, critics, the public, or verified users of the entities such as customers, and the name of the source. In other implementations, the predefined types of data might include menu items and their prices.

After step 303 is completed, the database 130 should, in some implementation, contain a mass of data relating to a large set of entities as compiled from one or more data sources 114 by information gathering module 126 and stored by database update module 128. In some implementations, the database 130 will contain information that is incomplete, conflicting, and/or inexact due to the nature of information available from data sources 114.

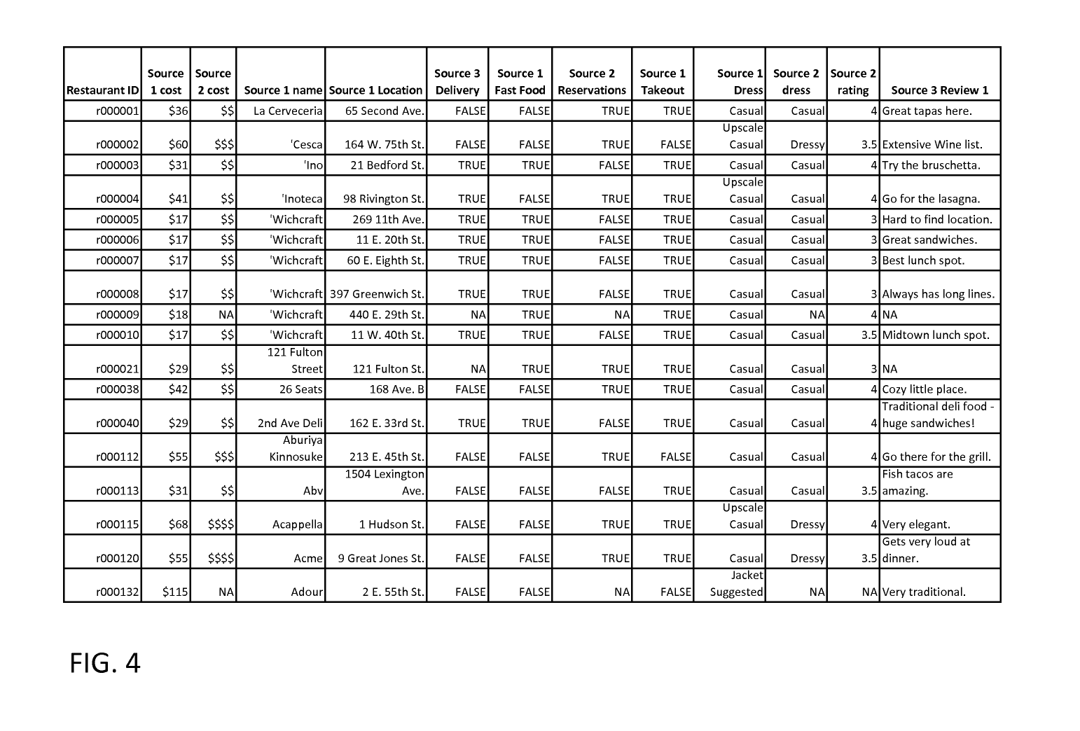

FIG. 4 shows a data table with a portion of data that a database 130 might contain after step 303 according to one embodiment. In practice, the amount of data and number of attributes gathered will likely be much greater than that shown in the data table. In this particular embodiment, each row corresponds to a restaurant identified by a unique Restaurant ID. There are columns of data from three different data sources 114, identified by number in the name of the attribute. In practice, the sources will likely be data sources such as Zagats.com or Yelp.com. The table contains example attributes from different sources including dollar costs in Source 1 Cost, names of the restaurants in Source 1 Name, textual reviews in Source 3 Review 1, locations in Source 1 Location. All of the attributes, but for the dollar cost, Source 1 Cost, can be used as predictor variables to predict dollar cost estimates leading to the Raw Grade. It will be understood by one skilled in the art that the database could take many forms (relational, distributed, etc.) other than the simple table displayed here.

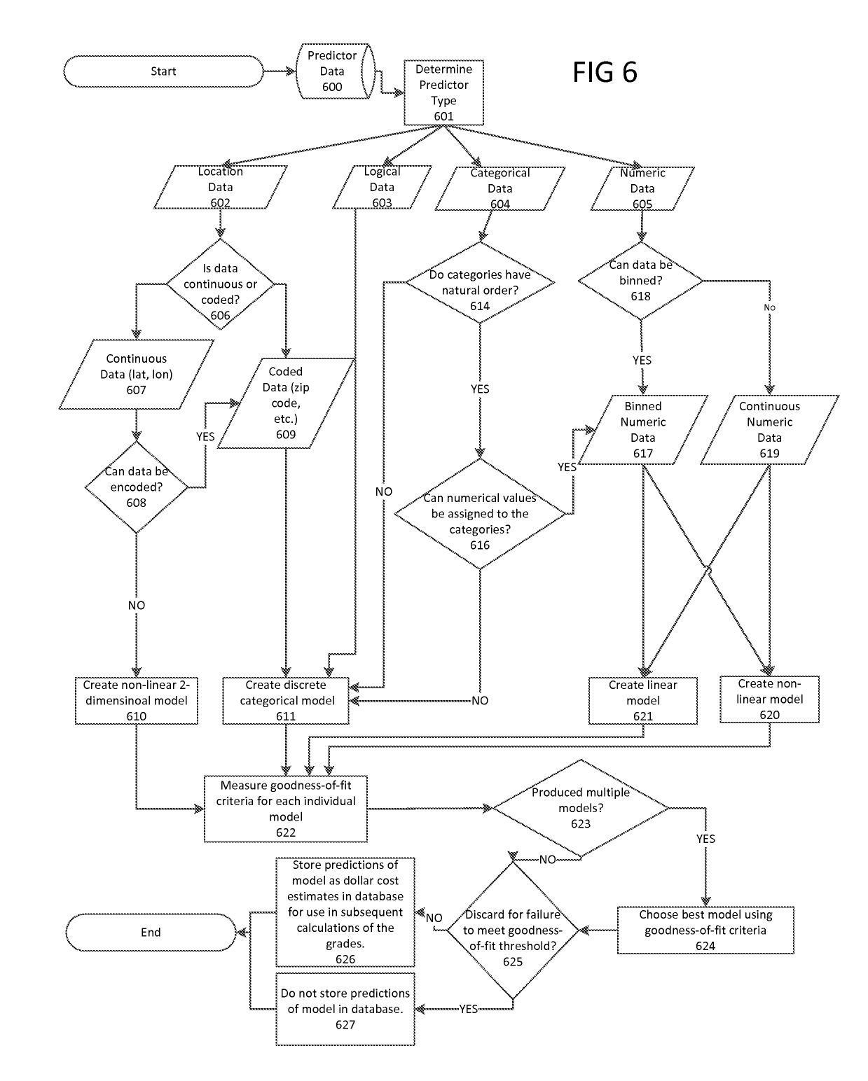

Attributes like each of those in the table of FIG. 4 will be used in some manner to calculate one of the analytics as explained with reference to the embodiment of FIG. 14. Predictor variables are involved in modeling dollar cost estimates, which are in turn necessary to calculate many of the analytics. It is, therefore, important to understand conceptually why costs in dollars are dependent on certain attributes, the predictor variables, in predicting dollar cost estimates. The following provide examples of why some of the attributes in FIG. 4 are predictor variables with correlations to cost. Source 2 Cost is not a dollar cost, but is a predictor variable containing categorically encoded dollar signs, $, $$, $$$, $$$$. Source 2 Cost clearly has a categorical relationship to cost in dollars that can predict dollar cost estimates, as shown in FIG. 6, using specific modeling techniques designed for categorical attributes. Attributes such as Source 1 Fast Food are considered predictor variables, because they are well known to have a correlation to dollar cost and/or a correlation to dollar cost can be mathematically determined. A fast food restaurant, for example, would often have a lower dollar cost per meal than a restaurant considered as fine dining. Predictor variables such as Source 1 Fast Food will be useful in predicting dollar cost estimates. Four additional attributes, Source 1 Fast Food, Source 3 Delivery, Source 1 Takeout, and Source 2 Takes Reservations, provide examples of logical attributes, which can assume the values TRUE or FALSE. Each of these attributes have an intuitive relation to cost and can predict dollar cost estimates using the same types of models as categorical attributes. Location data such as Source 1 Location also bears a relationship to cost, because upscale locations are more likely to have more expensive restaurants. Location data can therefore be used to model dollar cost estimates using a different type of statistical model. Modeling dollar cost estimates from such predictor variables will also be discussed with reference to FIG. 6.

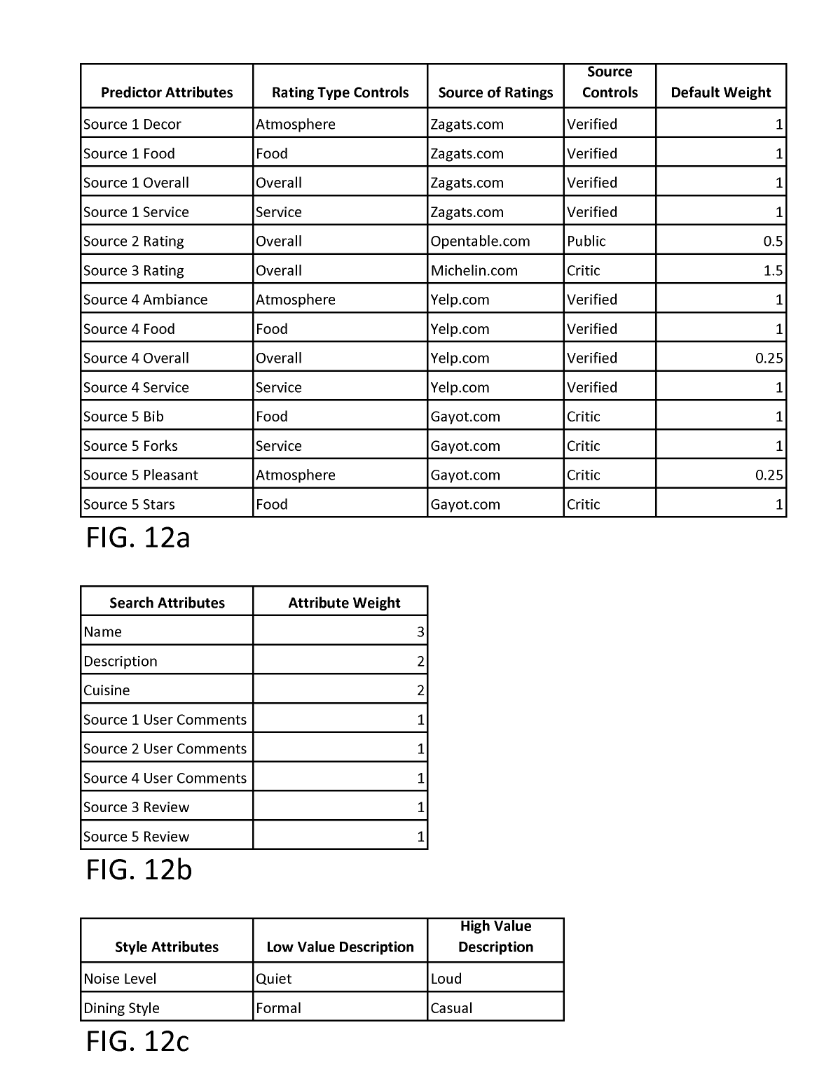

In step 303 of FIG. 3, data processing system 120 receives categorizations of the attributes stored in the database 130, and the categorizations are stored in that database 130 by database update module 128. The categorizations are used to relate user preferences to the specific attributes that are used to calculate certain of the analytics. In one embodiment, categorizations are made based on the user preference labels such as those appearing in the embodiment of FIG. 9. Such an embodiment is described with reference to the embodiment of FIG. 12a. Fields to be used for text searching are categorized and assigned a weight, as shown in in the embodiment of FIG. 12b. In one embodiment, attributes are categorized as style attributes (discussed in more detail below) are categorized in step 303, as shown in the embodiment of FIG. 12c. Categorizations can be input by humans who specifically identify each attribute as falling within specific categories. The categories will be used to relate particular attributes with user preferences in the calculations of the analytics as will be explained in more detail with reference to the embodiment of FIG. 9 and FIG. 14. In one embodiment, some attributes can be categorized programmatically without human intervention by using techniques such as assigning all variables from a given source to the same pre-determined category and by allowing all text fields to be searchable. In either case, these categorizations only need to be performed the first time that the database 130 is constructed from the data gathering process of step 302. For example, after the initial categorization carried out in step 303 based on the first formation of the database 130 in step 302, the database 130 can be updated with new information from the data sources and categorization as per step 303 will not be necessary. This is because the data obtained during the update will be of the same type that was obtained during formation of the database 130. In other words, although new information for a particular attribute may be gathered from the same data source 114 during the update, the attributes that were originally created in the database 130 will not change, because the same type of information will usually still be available from data sources 114. Only data in the records may change, but not the attribute types. Accordingly, the categorizations stored in the database 130 will still apply to the attributes. For example, if zagats.com was the data source 114, information such as the average star rating of a restaurant or user reviews may have changed since the original update, but they will still fall under the same attributes initially formed in the database 130.

In step 304 of FIG. 3, modeling module 122 calculates a cost expressed in dollars for each entity such as the calculated dollar cost or the adjusted dollar cost as described in U.S. patent application Ser. No. 14/592,449, which is hereby incorporated by reference, and database update module 128 stores the costs in a new column in the database 130. In other implementations, step 304 is not performed, and dollar costs that are already available in the database 130 are used in subsequent steps to predict dollar cost estimates.

In step 305, modeling module 124 receives identifications of predictor variables in the database 130. In one implementation, this is accomplished by examination of the stored attributes and selecting only those with data that is likely to result in a good correlation to cost. If, for example, an attribute in the database 130 relates to whether a restaurant serves fast food, an informative and useful model is likely possible between that attribute and dollar cost and it will be selected as a predictor variable. If, on the other hand, a text or categorical attribute has too wide a range of possible values, such as the name of the restaurant or the type of food, including it in subsequent steps may result in unreliable models, and ultimately unreliable dollar cost estimates. In different implementations, identifying predictor variables can be accomplished by human identification and/or by software in modeling module 124 that is programmed to identify attributes with desirable qualities such as particular data types or a limited range of values. In one implementation, modeling module 124 is programmed to rule out attributes with too wide an array of values such as could be the case with a column of restaurant names. Doing this programmatically, for example, by counting the number of unique values of an attribute and eliminating those that exceed a certain reasonable threshold, can be very efficient in the event that there are hundreds of attributes in the database 130, each of which a potential predictor variable. In one implementation, human identification of certain aspects of the predictor variables, such as whether the categories of a variable should be considered ordered (as in step 614 of FIG. 6), is performed first, and then the entire database 130 can be handled programmatically without further human intervention. In another implementation, modeling module 124 is programmed to consider every attribute a predictor variable, but as just noted, this would increase the resources used for modeling adjusted dollar cost.

In step 306, modeling module 124 generates dollar cost estimates and database update module 128 stores the best dollar cost estimates. In one implementation, step 314 involves modeling module 124 analyzing the predictor variables and calculating several models of dollar cost estimates from each predictor variable. In one implementation, database update module 128 only stores dollar cost estimates meeting a threshold goodness-of-fit, which means that some predictor variables might have no associated dollar cost. In this implementation, modeling module 124 first constructs one or more independent models of a cost in dollars for each predictor variable using only data for entities that have values for the predictor variables of interest and dollar costs available. The predictions of these models are dollar cost estimates but, in one implementation, it is possible that not all predictions will be stored for subsequent use in calculations of the analytics as is shown in the embodiment of FIG. 6. Although at least one model will be constructed for each predictor variable in step 306, it is desirable, in one implementation, to calculate multiple models based on different statistical methods and determine which model is the best. Depending on the type of data of which the predictor variable consists, different statistical methods are used to model the relationship between the predictor variable and cost (e.g., dollar cost or calculated dollar cost). In general, the types of data will be of the location type such as zip codes or latitudes and longitudes, of the numeric type containing integer or floating point values, of the logical type containing True/False or Yes/No data, or the character type that assumes a limited number of values, in other words a “categorical” field. An example of a character/categorical type of data that might be used as a predictor variable is a dress code attribute for a group of restaurants, which might assume values such as Casual, Upscale, and Jacket Required. In one implementation, depending on the data type and other factors, models that might be constructed for each predictor variable could be one or more of non-linear 2-dimensional models, discrete categorical models, linear models, or non-linear models. In one implementation, modeling module 124 then measures the goodness-of-fit for each individual model. The goodness-of-fit is derived from a plurality of statistical measures that quantify how well predictions match the predicted for a given model. In one implementation, goodness-of-fit is measured using the standard statistical coefficient of determination, R². In a second implementation, goodness-of-fit is measured using Adjusted R², which compensates for the effect of increasing the number of predictor variables. In a third implementation, goodness-of-fit is measured using the F-test, which allows for the use of weights in measuring the accuracy of the model, which might be desirable when some entities are deemed more important than others. There exist many statistical analysis software packages that can provide goodness-of-fit measures and that can be incorporated into modeling module 124 in different implementations. In one implementation, modeling module 124 then uses the goodness-of-fit measurements for each model to determine which individual model is best for each predictor variable. Essentially, in this implementation, the model with the best (by convention the best is usually the highest) goodness-of-fit is selected. This results in a single best-fit model for each predictor variable. All less attractive models are discarded. In one implementation, a threshold goodness-of-fit level as programmed into modeling module 124 is applied to determine if the best model selected for each predictor variable is good enough to provide a useful correlation between the predictor variable and cost. Therefore, in that implementation, if the best model's goodness-of-fit falls below the threshold value, no dollar cost estimate is stored for that predictor variable. In this implementation, if the best model's goodness-of-fit is above the threshold value, then database update module 128 stores that model's predictions as dollar cost estimates in the database 130. Further details regarding various embodiments of step 314 are provided in connection with the embodiments of FIG. 6 and FIG. 6A.

In step 307, modeling module 124 determines default weights for each predictor variable, which are then stored in the database 130 by database update module 128. These default weights will be used in the calculation of analytics, as shown in equations 8 and 8A. In order to calculate the default weights, according to one embodiment, the dollar cost estimates stored in step 306 are used as the dependent variables in a model with cost as the independent variable; the coefficients of the resulting model will be used to determine the default weights. After step 306 is complete, there will be a set of dollar cost estimates Dᵢ corresponding to the best model for each selected predictor variable. It is desirable to have a set of default weights wᵢ such that cost can be predicted as a linear combination of the dollar cost estimates:

$$Cost = {\sum }_{i} {D}_{i} * {w}_{i} + ɛ \qquad ( 1 )$$

In other words, the weights wᵢ quantify how useful each estimate Dᵢ is in understanding the cost of entities. In one embodiment, linear regression is solved using equation 1, minimizing epsilon. In this embodiment, wᵢ are the coefficients that result from solving the regression. It is also desirable that the weights satisfy the constraints:

Σᵢwᵢ=1 (2)

0≦tₘᵢₙ≦wᵢ≦1 (3)

Where tₘᵢₙ is a constant chosen as a minimum value for the weights. A suitable value for tₘᵢₙ might be (1/n)/4, where n is the number of dollar cost estimates. This captures the idea that every model should be included at a weighting that is at least 25% of the expected weight of 1/n. Solving for wᵢ can be performed in this case using quadratic programming optimization software, such as is provided in various statistical modelling packages such as R language using the quadprog package. The equations for obtaining the weights above assume that there is no missing data in any of the variables (that is to say, in order to apply it, only complete cases can be used). It is desirable to be able to include cases when there are missing values in one or more of the estimate Dᵢ. In one implementation, this can be accomplished by using the weights to combine available dollar cost estimates for each entity as follows:

$${Cost}_{j} = \{ \begin{matrix}{\sum }_{i} {D}_{j , i} * {w}_{i} / {\sum }_{i} {w}_{i} , & i \vert {D}_{j , i} is available \\ NA , & all {D}_{j , i} are NA\end{matrix} \qquad ( 4 )$$

This equation is now non-linear because of the NA handling, but can also be solved to satisfy the constraints on wᵢ using generalized numerical optimization methods, such as are implemented in various statistical modelling packages, e.g. in the R language using the optimize or rsolnp packages. In various embodiments, the default weights are set to be equal, e.g., 1/n, set in proportion to the goodness of fit and satisfying equations 2 and 3, chosen to satisfy equations 1, 2, and 3, chosen to satisfy equations 4, 2, and 3, or set according to a priori considerations, and satisfying equations 2 and 3.

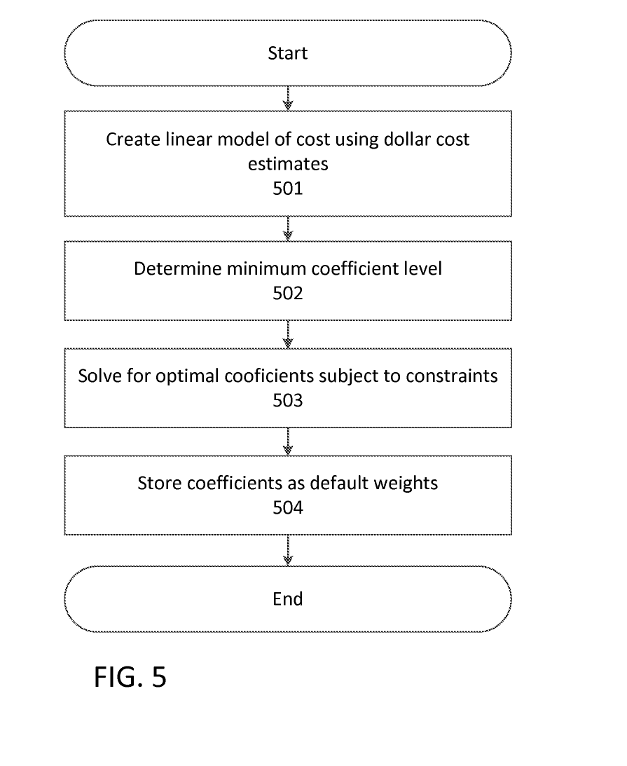

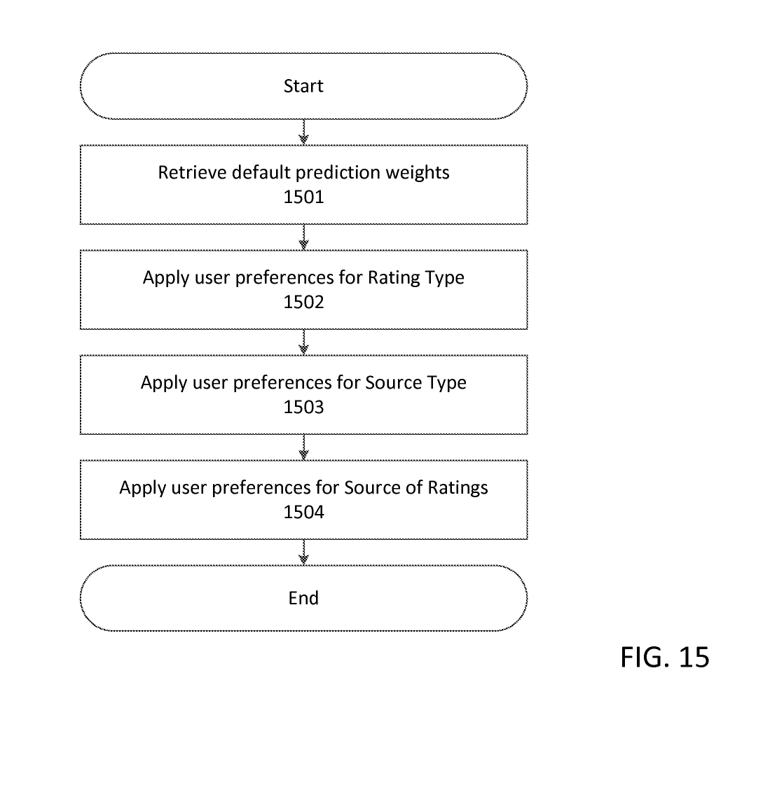

FIG. 5 shows a process of the calculating and storing default weights according to one embodiment. In step 501 a linear model of cost is set up, using the dollar cost estimates as independent variables, as in equation 4. In step 502 tₘᵢₙ is chosen, as in equation 3. In step 503, equation 4 is solved via optimization, using equations 2 and 3 as constraints. In step 504 the optimal solution values for wᵢ are stored as the default weights. Further details concerning default weights are described in connection with the embodiments of FIG. 12a, FIG. 14 and FIG. 15.

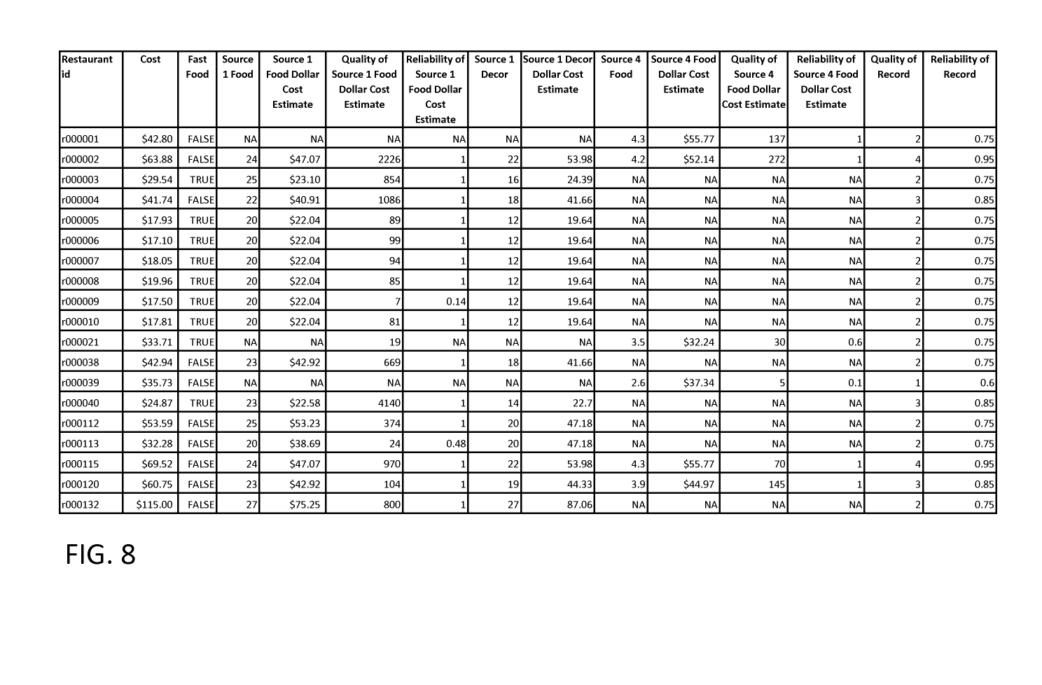

Returning to FIG. 3, in step 308 modeling module 124 receives an identification of quality values for each dollar cost estimate and database update module 128 stores the dollar cost estimate quality values in the database 130. Quality values are used as a measure of the accuracy of the information used to create the dollar cost estimates. In one embodiment, the quality ratings for dollar cost estimates already exist in the database as the values of another attribute that was obtained from data sources 114. In this embodiment, it is not necessary to store the quality values as new attributes since they already appear in the database. To identify the attribute, modeling module 124 is programmed to recognize that the values of that attribute are to be used as the quality values in each record with respect to a particular set of dollar cost estimates generated from the values of a specific predictor variable. Further details regarding the quality values received in step 308 are provided with reference to the embodiment of FIG. 8. In other embodiments, an attribute identified as having quality values for a specific set of dollar cost estimates is copied and stored as another column in the database 130, and the attribute is given a new name identifying it as a quality attribute such as Quality of Source 1 Food Dollar Cost Estimates in the embodiment of FIG. 8. In this embodiment, it is also necessary to identify the attribute as a quality attribute and program modeling module 124 to recognize that the values of that attribute are to be used as the quality values for a particular dollar cost estimate. In one embodiment, the number of reviews associated with an attribute is used as quality data for that attribute. In another embodiment, where entry quality data is not available in whole or in part, a suitable default value can be used for the missing entries' entry quality data. A dollar cost estimate might be based on a predictor variable for which no quality measure is available. In this case, it is desirable to assign a default value for dollar cost estimate quality as chosen with respect to the threshold. For example, if the predictor in question is considered to be completely reliable, all quality entries for that predictor could be set to the threshold value, resulting in a reliability of 1, as will be clear from the description of step 309.

In step 309 modeling module 124 calculates reliability values for each dollar cost estimate, and database update module 128 stores the dollar cost estimate reliability values in the database 130. The dollar cost estimate reliability values quantify the certainty with which the dollar cost estimate values are known to be true. As an intuitive example, consider an attribute that is a rating of an entity having a value of 4.0. That value may represent the average of 100 different individual users' ratings, or it may represent just a single user's rating. The rating of 4.0 for entity A with 100 user reviews is more reliable than for entity B with just 1 user review. A mechanism for defining dollar cost estimate reliability is:

reliability=min(quality/quality threshold,1) (5)

where quality is a non-negative value, and quality threshold is a positive constant, above which reliability assumes its maximum value of 1. In the example given above, if the quality threshold is 100, then the dollar cost estimate reliability of rating would be 1 for A and 0.01 for B. An entity C with 500 reviews would have a dollar cost estimate reliability of rating of 1 as well, a feature that is beneficial so that the scale of dollar cost estimate reliability is not distorted. Another embodiment defines reliability as:

reliability=min(f(quality/quality threshold),1) (6)

where f( ) is any monotonically increasing function. For example, f(x)=x^{1/2} would result in higher reliability values for entries with intermediate quality.

In step 310 modeling module 124 receives an identification of quality values for each record and database update module 128 stores the record quality values in the database 130. Much like with the dollar cost estimate quality values, in one embodiment, record quality values are simply determined by a human as the value of another attribute in the database 130, thereby eliminating the need for storing them again as a new attribute. In another embodiment, if record quality values are taken as some combination of attributes (e.g. an average of two other attributes), then this calculation is performed by modeling module 124, and results stored as the record quality values in a new attribute.

In step 311 modeling module 124 calculates reliability values for each record and database update module 128 stores the record reliability values in the database 130. The record reliability quantifies the extent to which the overall information about an entity may be relied upon. Record reliability is calculated, in different embodiments, using equation 5 or 6 by associating a quality measure with the entire record. In one embodiment, record reliability is calculated using the number of databases in which an entity appears. Further details regarding step 308 through step 311 will be discussed with reference to the embodiments of FIG. 8.

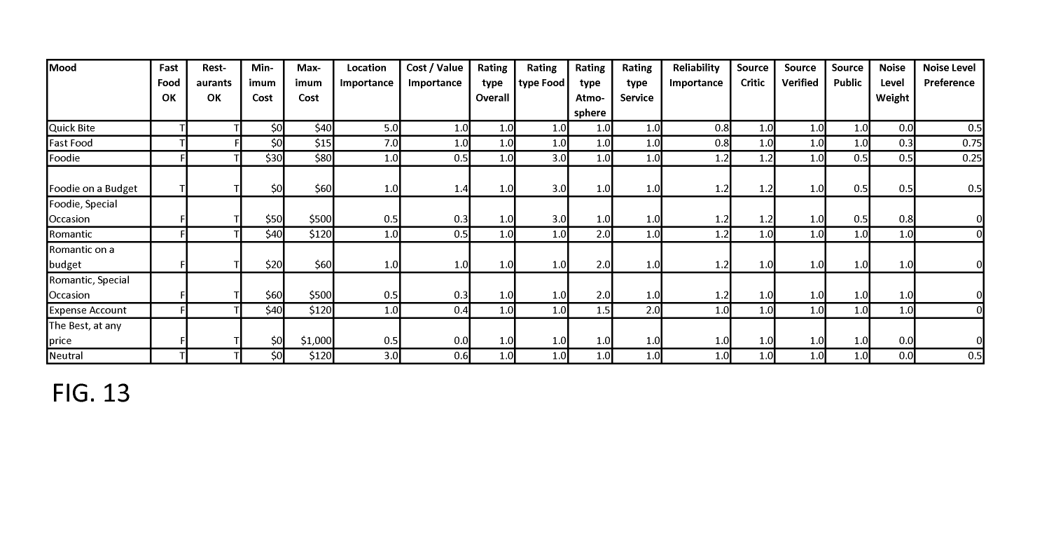

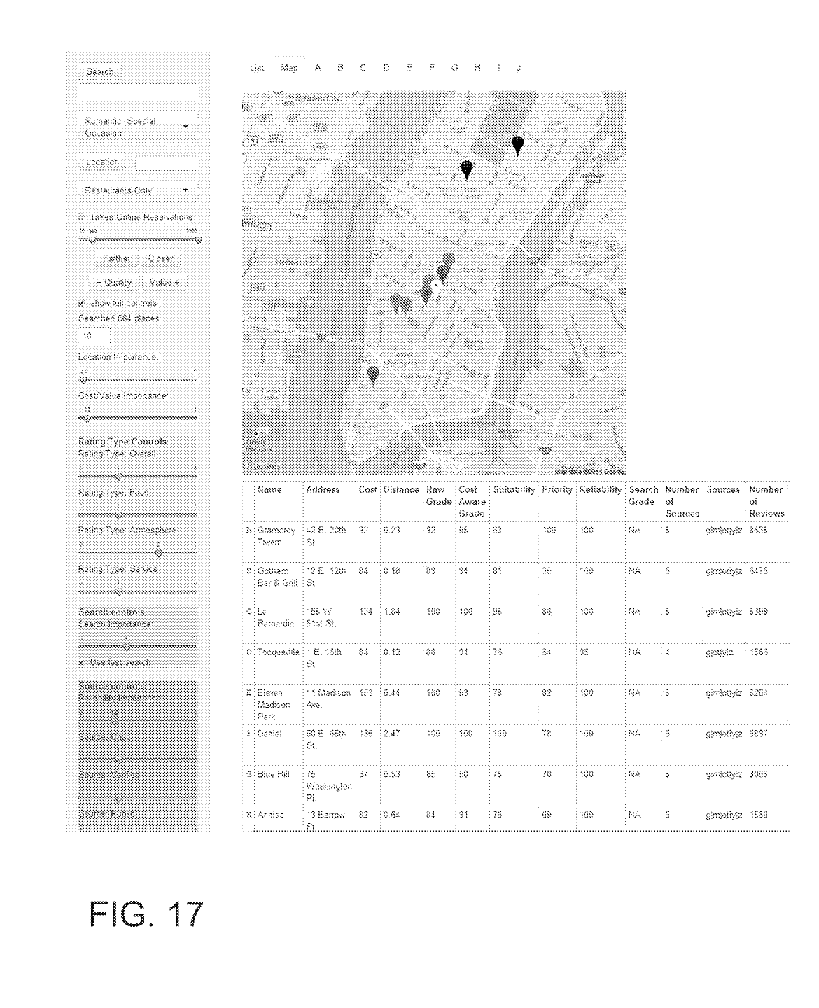

In step 312, data processing system 120 receives and database update module 128 stores default values for “Moods”. A mood is associated with a set of pre-determined user preferences. Moods are explained in more detail with reference to FIG. 9, FIG. 13, FIG. 14, and FIG. 17. In one embodiment, default values are chosen and provided to data processing system by a human such that the default values are received by data processing system 120. These default values are utilized, in one embodiment, in the calculation of analytics as per the embodiment of FIG. 14. Further details regarding the use of default values received in step 312 will be provided with reference to the embodiments of FIG. 9 and FIG. 13.

FIG. 6 shows a flowchart for the individual modeling process and the selection of dollar cost estimates to be used in subsequent calculations of the analytics according to one embodiment. As such, FIG. 6 provides additional disclosure regarding step 306 of FIG. 3 according to one embodiment. In one embodiment, the process in FIG. 6 can be automated, using various computer scripting methods. In another embodiment some steps, such as step 614, could optionally involve human determinations and data processing system 120 would receive input regarding the determinations prior to a complete automated pass through all the available predictor variables.

There exist many widely available software packages that are capable of generating different types of statistical models as well as calculating goodness-of-fit such as those in the embodiment of FIG. 6 that would be known to one of ordinary skill in the art with the present disclosure before them. For example, the statistical language R includes a mechanism for specifying the dependent and independent variables of a model, here each predictor variable and the actual dollar cost respectively, and generating and evaluating a wide range of linear and non-linear models. An automated modeling process is essential when dealing with databases that may have hundreds of possible predictor variables, which may be used individually or in combinations.

The process begins in step 601 by determining the type of data present in a single predictor variable from a set of predictor variable data 600 that is available in a database 130. The data may be determined to be of the location type 602, logical type 603, categorical type 604, or numeric type 605. In one implementation, a software application can be written that examines the declared type of data in the database 130. Data in the database 130 may already be properly typed, that is, identified as containing character, logical, categorical, numerical, or location data. It may be the case, however, that data is not typed, i.e., the data consists of all character attributes. Although one skilled in the art of data analysis would generally be able to assign types to the attributes by inspection, it is also useful to be able to assign types programmatically. The following pseudo-code is one embodiment of a type assignment function, operating on an attribute:

$$ImpliedType < \text{-} function ( x , CategoricalThreshold = 20 ) \\ \{ \\ \# assign type to attribute x , based on its content \\ I f x has 2 columns , with {names }^{″} {lat}^{″} {and }^{″} {lon}^{″} \\ then return {(}^{″} {location}^{″} ) \\ If all non \text{-} missing values of x are \\ in {(}^{″} {Y}^{″} {,}^{″} {N}^{″} {,}^{″} {YES}^{″} {,}^{″} {NO}^{″} {,}^{″} {TRUE}^{″} {,}^{″} {FALSE}^{″} ) \\ then return {(}^{″} {logical}^{″} ) \\ If all non \text{-} missing values of x can be converted \\ to numbers without error \\ then return {(}^{″} {numeric}^{″} ) \\ U = ( the number of unique values of x ) \\ If U < CategoricalThreshold \\ then return {(}^{″} {categorical}^{″} ) \\ Otherwise \\ return {(}^{″} {character}^{″} ) \\ \} \qquad ( 7 )$$

This pseudo code can be written in a number of suitable programming languages and uses to assign types in the database 130. Special cases might require slightly more complex but readily apparent code. For example, zip code data might be distinguished from ordinary numeric data by looking for attributes that were exactly 5 or 9 digits long.

If the data is of a location type 602, then a determination is made in step 606 as to whether the data is continuous 607 such as an exact location specified by latitudinal and longitudinal coordinates or coded data 609 such as zip code or neighborhood. Coded data 609 is fit to a discrete categorical model 611 such as a simple mean-estimation model to predict dollar cost estimates. As with all of the models discussed in FIG. 6, readily available statistical software packages are programmed and stored in modeling module 124 that predict dollar cost estimates. If the location data is continuous 607, then an attempt to encode the data 608 is made. If successful, then two routes are followed. First, the newly encoded data 609 is analyzed using a discrete categorical model 611. Simultaneously, the non-encoded version of the continuous data is analyzed using non-linear 2-dimensional model 610. Thus, multiple models may be evaluated using the same predictor variable.

Logical data 603, which by its very nature is discrete categorical data 621 is always fit with a discrete categorical model 611. Categorical 604 data, however, can lead to three different types of models. With categorical data 604, a determination may be made by human inspection as to whether the data has a natural order 614 such as $, $$, $$$, $$$$. If not, then only a discrete categorical model 611 is used. If the data has a natural order 615, then an attempt may be made to assign numerical values to the data 616. The non-numerical version of the data is then modeled discrete categorical data 611. If successful, the data is binned 617. Binning is a process whereby values in a certain range are considered to have the same value. For example, values in the range 0-30 might be assigned to 4 bins: 0-15, 15-20, 21-25, and 25-30, with each bin being assigned a single value. As this example makes clear, binning does not necessarily need to be on equally spaced intervals, or split the data into bins with equal number of entries. The purpose of binning is to improve the robustness and stability of a model, making it less sensitive to outliers. Binned numeric data is very similar to ordered categorical data. In the example just mentioned, if the bins are assigned values 1, 2, 3, and 4 then this is exactly equivalent to ordered categorical data with values 1, 2, 3, and 4. If the bins are assigned (non-linear) values such as 7.5, 17.5, 22.5, and 27.5 (corresponding to the average of their respective ranges) then modeling results will be slightly different. As another example, ordered categorical data such as $, $$, $$$, $$$$ representing the cost of a restaurant symbolically might be assigned arbitrary linear numeric values 1, 2, 3, and 4, or non-linear values such as 20, 35, 60, 100. The binned data 617 is then tested with linear 621 and possibly more than one non-linear model 620 such as the Loess model.

With numeric data 605 an attempt to bin the data 618 is made. The binned numeric data will be modeled both linearly 621 and non-linearly 620. The un-binned version in the form of continuous numerical data 619 can also be tested linearly 621 and with one or more non-linear models, which, as mentioned above, often result in better predictions of cost than linear models.

Following the generation of all possible models for each predictor variable, a goodness-of-fit value for each model is generated 622. Next, a determination as to whether one or more models have been generated is made. If multiple models have been generated 623, the best model is chosen by comparison of their goodness-of-fit values 624 and selecting that with the highest goodness-of-fit. Even after the best model is chosen, it may still be discarded 627 if its goodness-of-fit value falls beneath a threshold value 625. Similarly, if it is determined that only one model is generated 623, that model is also checked as to whether it meets the threshold value 625. In step 626 the predictions of models with a goodness-of-fit meeting the threshold value are stored as dollar cost estimates in the database 130.

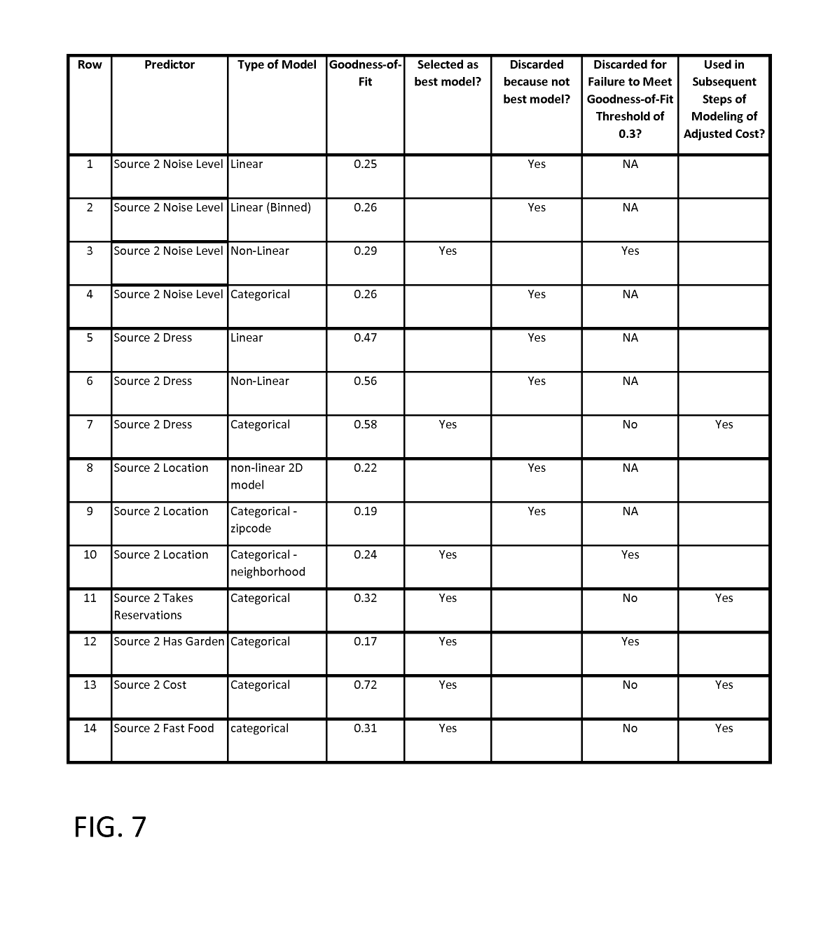

FIG. 7 shows a table that exemplifies how the goodness-of-fit is applied to the modeled predictor variable data according to one embodiment. FIG. 7 consists of a table with a selection of predictor variables, all from the same source, their goodness-of-fit measures, and columns indicating of how steps 624 through 627 of FIG. 6 are applied to actual data. In this example, a selection of models based on a selection of predictor variables is shown. Multiple models have been generated for some predictor variables. For example, the predictor variable Source 2 Noise Level, which is a numerical attribute, has four different models associated with it. By contrast, the predictor variable Source 2 Takes Reservations has only one model, a categorical model, associated with it, because it can only assume the values TRUE or FALSE. For each model, a Goodness-of-Fit value is shown, where higher values indicate a better fit. The Goodness-of-Fit threshold has been set to 0.3 in this example, which results in a total of dollar cost estimates being stored for subsequent use in calculating the analytics. Of the four models associated with the predictor variable Source 2 Noise Level, the best is the non-linear model with a goodness-of-fit value of 0.29, which is lower than the threshold value of 0.3. Accordingly, all four models are discarded. Of the three models associated with the predictor variable Source 2 Dress, the best is the categorical model, and its goodness-of-fit level is also above the threshold value. Of the three models associated with the predictor variable Source 2 Location, the best model is the categorical model based on neighborhood, but the goodness-of-fit for this model is only 0.24, below the threshold of 0.3. Therefore, no models for this predictor variable are included. The models for Source 2 Takes Reservations and Source 2 Has Garden each have no competitors, but only the categorical model for the predictor variable Source 2 Takes Reservations will be used, because the categorical model for the predictor variable Source 2 Has Garden, with a goodness-of-fit value of 0.17, is below the goodness-of-fit threshold. Any discarded attributes will no longer be considered predictor variables and their modeled predictions, i.e., their dollar cost estimates, will be discarded as well.

FIG. 8 shows an exemplary table from a database 130 with columns for the dollar cost estimates calculated in step 306 along with columns for the quality and reliability values calculated in step 308 through step 311. Dollar cost estimate columns have been added next to the predictor variable columns from which they have been predicted. Three predictors are shown: Source 1 Food, Source 1 Decor, and Source 4 Food. Source 1 Food Dollar Cost Estimate is calculated using a joint model to predict cost, using the attributes Source 1 Food and Fast Food. Accordingly, Source 1 Food Dollar Cost Estimate is the expected cost for a restaurant with a given Source 1 Food rating and Fast Food status, leaving aside any other information. An examination of the values in these fields will show that Source 1 Food Dollar Cost Estimate increases as Source 1 Food increases, and that for a given value of Source 1 Food, Source 1 Food Dollar Cost Estimate is much higher for Fast Food=TRUE than for Fast Food=FALSE. For example, for restaurant 38 (rid=r000038), the value of Source 1 Food is 23, Fast Food is FALSE, and Source 1 Food Dollar Cost Estimate is $42.92. By contrast, for restaurant 40 (rid=r000040), the value of Source 1 Food is also 23, but Fast Food is TRUE, and Source 1 Food Dollar Cost Estimate is $22.58. This reflects the fact that fast food restaurants are generally much less expensive than non-fast food restaurants. For example the Cost for row 38 is $42.94, whereas the Cost for row 40 is $24.87.

Two attributes from the same source, Source 1 Food and Source 1 Decor, describe different aspects of a restaurant's desirability. The associated dollar cost estimates, Source 1 Food Dollar Cost Estimate and Source 1 Decor Dollar Cost Estimate, reflect the estimated costs of achieving a given rating based on each the related predictor variables. Notably, the estimated costs of a given numerical rating are different for different predictor variables. For example, for restaurant r000113, a Source 1 Food rating of 20 corresponds to a dollar cost estimate of $38.69, the same rating of 20 for Source 1 Decor corresponds to a dollar cost estimate of $47.18. This reflects the fact that, statistically, higher decor ratings are achieved more exclusively by the most expensive restaurants than are higher food ratings. A given restaurant may make investments in providing quality to its customers, which is reflected in the ratings that are achieved in the different aspects. By allowing users 106 to express preferences for different aspects of quality, for example by prioritizing food over service or decor, a user 106 can make more meaningful comparisons between restaurants that emphasize one aspect over another, and choose the most suitable one.

The column Quality of Source 1 Food Dollar Cost Estimate contains values used to measure values of Source 1 Food Attribute (step 308). In this example, it is taken to be the number of reviews of the entity in Source 1. The column Reliability of Source 1 Food Dollar Cost Estimate is calculated using this quality field according to equation 6, using a quality threshold of 50 (step 309). For example, restaurant r000004 with a quality value of 1086 and restaurant r000005 with a quality value of 89 both have a reliability value of 1 (since reliability is capped at 1, for all restaurants with a quality value at or above the threshold). Restaurant r000009 with a quality value of 7 has a reliability of 0.14 (=7/50).

The columns Quality of Record (step 310) and Reliability of Record (step 311) in this example are based on the number of sources for which information on a given entity is available. In this example, values in the Reliability of Record column are calculated using the more general equation 7, in which a monotonically increasing non-linear function is used, and record reliability value for quality values of 0, 1, 2, 3, 4, 5 is taken to be 0, 0.6, 0.75, 0.85, 0.95, 1 respectively.

The presence of many NA (not available entries) in various columns indicates that no information was available from that source for a given restaurant. For example, restaurant r000001 is not present in source 1, whereas restaurant r000003 is not present in source 4. A user 106 accessing a single source of information would be limited to choices present in that source, but here the user 106 benefits from a wider range of choices due to obtaining information from multiple data sources 114.

The table in FIG. 8 also shows the usefulness of a common scale for ratings of different types and sources. All of the dollar cost estimate columns of FIG. 8 are in the same units of dollars. This enables simple dollar comparisons not only between ratings of different aspects of the restaurants (such as the Source 1 Food and Source 1 Decor, which are on a scale of 0-30), but also with ratings from other sources that use completely different scales (such as Source 4 Food, which is on a scale of 1 to 5). In one embodiment, the user 106 is presented with the dollar cost estimates as part of the results. In another embodiment, the user 106 is not presented with dollar cost estimates as part of the results. In another embodiment, the selection of user preferences results in a blend of these dollar cost estimates being presented to the user 106.

FIG. 9 shows an exemplary form that provides users 106 with a search mechanism for entities of interest using inputs for a novel set of user preferences that relate to information collected from one or more data sources 114. FIG. 10 shows an exemplary table of results returned to the user 106 following receipt by data processing system 120 of user preferences selected by the user 106 according to one embodiment, together with a map showing the location of the entities. The table in FIG. 10 includes analytics that are generated from the novel systems and methods described in the embodiment of FIG. 14 based on both the user preferences received by data processing system 120 and the data stored in the database 130. In one embodiment, the portions of webpages in FIG. 9 and FIG. 10 appear in a single webpage that is sent to the user 106 the first time the user 106 requests the page or following a search. In different embodiments, the form for inputting user preferences in FIG. 9 and the results in FIG. 10 can be received and sent to the user 106 for use by a dedicated interface in an app or application instead of a browser.

In the example form of FIG. 9 and table of results of FIG. 10, the user preferences and results including the analytics relate to restaurants. For purposes of continuity, all of the embodiments of the figures provided in this patent use a specific naming convention for the user preferences and for the analytics that is suited to restaurants. In other implementations, however, user preferences can be created for any type of consumer entity and the same set of analytics can be generated using the same processes and mathematical techniques disclosed with reference to the embodiment of FIG. 14.

Turning to FIG. 9, on the form for user 106 to input user preferences, each input has a label corresponding to the name of the user preference. The labels and inputs for each user preference and their relation to the calculation of one or more analytics in this example will be explained from the top of the page to the bottom of the page and left to right of the form. Further details regarding the relation of the user preferences to processes and calculations involved in generating the analytics will be provided with reference to FIG. 12 and FIG. 14.

The first user preference is an input appearing at the top of the form as a text box with a button labeled “Search”. Here, the user 106 can enter any text to perform a search for restaurants. As described with reference to the embodiment of FIG. 14, a “fuzzy” text search is used to narrow the range of results of the search. In one embodiment, search and query module 126 will have already have been programmed to utilize certain attributes in the database 130 to return results as is shown in the embodiment of FIG. 12b. For example, search and query module 126 may be programmed to search attributes such as restaurant name and textual comments by critics or patrons.

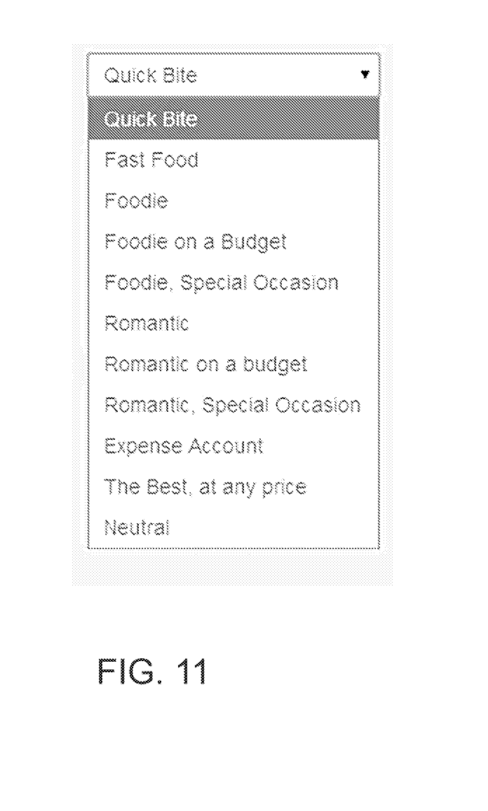

The dropdown menu labeled “Quick Bite” is the only option on the webpage that is not a user preference but a quick means of selecting values for other user preferences. When the user 106 clicks on the drop down menu a list of unique options, or “moods”, are displayed in the drop down menu. FIG. 11 shows the drop down menu extended such that all the possible options available to the user 106 are visible according to one embodiment. In one embodiment, by choosing a mood from the drop down list, the user 106 does not need to complete the entire form by choosing values for each preference, because the values for each of the user preferences automatically change to the default values for that mood such as those shown in FIG. 13. In this embodiment, if the user 106 then submits the form, data processing system 120 will receive the user preferences with the default values for that mood as though the user 106 had selected values equivalent to those default values for that mood. Further details regarding moods are provided with reference to the embodiment of FIG. 13, FIG. 14, and FIG. 17.

The next user preference is text box to the right of the button labeled “Location” for entering the desired location for the search. In one implementation, the location is used in conjunction with the user preference below labeled “Location Importance” to determine which restaurants will be included in the results based on the attribute storing the restaurants' locations in the database 130. These two user preferences are also used in calculating certain analytics as will be described with reference to the embodiment of FIG. 14. The buttons labeled “Farther” and “Closer” are not user preferences but relate to distance, because they provide the user 106 with an easy means by which to alter the Location Importance parameter, and immediately initiate a new search with the updated preference.

The next user preference is a drop down menu labeled “Restaurants & Fast Food”. This drop down menu also contains the individual options for only “Restaurants” or only “Fast Food”. This user preference is used to filter out restaurants that are correspond to the options in the attribute in the database 130 that includes values for the characteristic of each restaurant as being either a Restaurant or a Fast Food restaurant. Restaurants not matching the selected value of this user preferences will not appear in the results provided to the user 106.

The next user preference is a check box labeled “Takes Online Reservations” that is also used as a filter, in this case to filter out restaurants that do or do not take online reservations from being included in the results.

The next user preference includes two buttons labeled “+Quality” and “Value+”. These buttons are used to conveniently decrease or increase the value of the user preference Cost/Value Importance, and immediately initiate a new search with the updated preference.

The next user preference is shown as a slider input with, in this example, values of $0 and $40 selected. This user preference is also used as a filter. Specifically, it is used to filter out restaurants that have costs in dollars falling outside the selected range as determined based on the dollar cost utilized in this specific embodiment. As explained above, different embodiments of this invention can utilize different costs in dollars, such as dollar costs or calculated dollar costs, for purposes of generating results and analytics and for purposes of filtering the database 130 on the basis of the values selected on this slider. Restaurants not falling within the selected dollar range of this user preferences will not appear in the results provided to the user 106.

The next user preference is labeled “Cost/Value Importance”, which allows the user 106 to control how important value for the money is in determining results. Embodiments of this invention focus on a novel means of relating cost to value based on certain predictor variables and the costs in dollars used in the particular embodiment. Cost/Value Importance appears in step 1406 of FIG. 14, and is involved in calculating the analytics presented in the results to the user 106. A high Cost/Value importance signifies that the user is less willing to spend more to get a marginal improvement in quality.

The next set of user preferences are the four sliders beneath the heading “Rating Type Controls”, which are in turn labeled “Rating Type: Overall”, “Rating Type: Food”, “Rating Type: Atmosphere”, and “Rating Type: Service”. Based on the categorizations such as those described with reference to the example of FIG. 12a, data processing system 120 associates the values of each of the Rating Type Controls with predictor variables that have been categorized according to one of these four user preferences. Since there is a dollar cost estimate for each predictor variable, each of these four user preferences are, in turn, associated with the dollar cost estimates generated from predictor variables (such as those falling into categorizations in the table of FIG. 12a under the heading Rating Type). In this manner, the values for each Rating Type are applied only to the dollar cost estimates falling within their respective categorization when calculating the analytics as per step 1402A of the embodiment of FIG. 14. Accordingly, each of the four sets of preferences act as multipliers for the weights of potentially hundreds of dollar cost estimates per entity that will be used to generate analytics and order the results such as those shown in the table of FIG. 10. The Rating Type Control user preferences are significant in that they are providing an additional layer of control and convenience for the user, allowing weights to be adjusted simultaneously for many dollar cost estimates.

The next user preference is a slider labeled “Search Importance”. Search Importance is used in the calculation of Search Grade 1422, as explained below in discussion of step 1409.

The next set of user preferences appear as three sliders under the heading “Source Controls”, which are labeled “Source Critic”, “Source Verified”, “Source Public” (a slider labeled “Reliability Importance” also appears under the heading “Source Controls, which will be explained separately). These three user preferences are used by data processing system 120 in much the same way as the Rating Type Controls in that they both inform data processing system 120 what predictor variables they relate to based on the categorizations in FIG. 12a and how to determine dollar cost estimate weights. Here again, there may be, for example, one-hundred different predictor variables stored in the database 120 that are categorized as being based on the reviews of Critics. Conflicts can exist between authoritative information (such as that provided by critics) and comprehensive information (such as that provided by the public). Authoritative sources do not include information on all possible entities. Comprehensive sources, on the other hand, cannot be authoritative, because there can be no uniform standard for evaluating all entities. A means for blending information from sources of both types helps to resolve this conflict. A user 106 who values information from authoritative sources such as, for example, Michelin.com can assign a high weight to this source while still having the benefit of seeing other possibilities from among the many restaurants that Michelin has not provided ratings for.

The next user preference is a slider labeled “Reliability Importance”, which controls the extent to which less reliable information is penalized in the calculation of analytics. Further details regarding the use of the Reliability Importance user preference are described with reference to the embodiment of FIG. 14.

The next set of user preferences are check boxes falling under the heading “Source of Ratings”, which are in turn labeled “Zagat”, “OpenTable”, “Michelin”, “Yelp”, and “Gayot”. Each of these user preferences also functions to delineate a set of predictor variables such as the categorizations in the example table of FIG. 12a (i.e., the values in the column Source Controls). These five user preferences only function, however, as filters to filter out predictor variables and their associated dollar cost estimates from being included in the calculations of the analytics. For example, if the check box labeled Zagat is unchecked, none of the dollar cost estimates associated with the predictor variables categorized as being obtained from the data source 114 Zagats.com in FIG. 12a would be used in the calculations in the process described with reference to the embodiment of FIG. 14. In this manner, the values for the user preferences for Rating Type Controls and Source Controls are applied only to the dollar cost estimates associated with the Source of Ratings check boxes that are received as checked when calculating the analytics as per step 1402 of the embodiment of FIG. 14. Dollar cost estimates categorized according to an unchecked box are not used in the calculations of the analytics as per step 1402 of the embodiment of FIG. 14.

The final set of user preferences is labeled “Noise Level Preference”. There are two slider inputs, for Noise Level Preference, and for Noise Level Importance. The first slider allows the user 106 to select whether the restaurant is “Quiet” or “Loud”. This user preference is considered a “style” preference as will be explained with reference to step 1410 of the process described in FIG. 14. In the example shown in FIG. 9, the Noise Level Importance is set to 0, indicating that Noise Level will not be considered in the outcome of the search.

FIG. 10 includes a table of results that were generated based on the user preferences shown on in the form of FIG. 9. The table includes rows for each of the restaurants resulting from the search. The columns contain either factual information about restaurants such as their name and location or the values of the analytics. The values of the analytics are calculated according to the process in the embodiment of FIG. 14.

FIG. 12a shows an exemplary table of categorizations received and stored in step 303 of FIG. 3 and default weights generated and stored in step 307 as they are applied to predictor variables stored in a database 130 according to one embodiment. This table represents the link between certain user preferences discussed in FIG. 9 to data such as that in FIG. 8 for purposes of calculating analytics according to the process in the embodiment of FIG. 14. The information in this table represents properties of the predictor variables, and is therefore the same for every value of that predictor variable and its associated dollar cost estimate.

The first column in the table, Predictor Variables, contains the name of specific predictor variables in each row. The names of the predictor variables result from the collection of data from different data sources, each of which can use its own naming convention and value types for different predictor variables. Since there are often hundreds of predictor variables to contend with, it is helpful to categorize each predictor variable into a set of specific categories such that the user 106 is presented with a reasonable number of categorical options in the user preferences to choose from. Here, categories appearing as the values in the column Rating Type Controls match categories in the screenshot of FIG. 9 under the heading “Rating Type Controls”. Accordingly, this allows Modeling Module 124 and Search and Query Module 126 to link the user preferences to the many different predictor variables to which they apply in the calculation of the analytics as is discussed with reference to the embodiment of FIG. 14. When a user 106 inputs a preference corresponding to one of these rating types, search and query module 126 retrieves the requisite data corresponding to the predictor variables that have been categorized in step 303 of FIG. 3 and passes the data to Modeling Module 124 for calculation of the analytics. As will be explained with reference to the embodiment of FIG. 14, the dollar cost estimate weights determined, in part, from the user preferences for these categories are used to weight the importance of the dollar cost estimates relating to the predictor variables in the corresponding category for purposes of calculating the analytics. It is possible for multiple predictors from the same data source 114 or from different data sources 114 to be categorized as the same Rating Type Control. For example, in FIG. 12a, both Source 1 Decor and Source 4 Ambience are categorized as Atmosphere. Similarly, predictor variables from the same data source 114 can be categorized as the same Rating Type Control. Source 5 Bib and Source 5 Stars both fall under Food. Accordingly, user preferences for Rating Type Controls determine how an entire set of predictor variables related to one or more entities is used in calculations of the analytics.

The third column in the table is Source of Ratings, which contains the names of the data sources from which each predictor variable was obtained. Similar to Rating Type Controls, the Source of Ratings categories match the user preferences under the heading “Source of Ratings” in the form of FIG. 9. As was explained with reference to FIG. 9, however, these categories are used to filter out information related to the corresponding predictor variables from the calculations of the analytics. Only predictors from the sources the user 106 requests by checking the appropriate box will be used in calculations of the analytics and generating a response to the user 106.

The fourth column in FIG. 12a is Source Controls. Here again, the values in the column Source Controls match those for the options under the headings “Source Controls” in FIG. 9. As was explained with reference to FIG. 9, Source Controls refers to the source of predictor variables, which could be a critic, the public, or a verified source such Zagat.com or Opentable.com that compiles ratings from verified restaurant patrons. Information specifying the Source Control of predictor variables is commonly available from data sources 114, and often times many predictor variables from the same data source will have the same Source Type. Again, as shown in FIG. 9, the user 106 is able to select values for specific “Source Controls”, which means that predictor variables and their corresponding dollar cost estimates in those categories will be weighted, in part, based on user preferences for “Source Controls”.

The fifth column in FIG. 12a, Default Weight, contains default weights calculated in step 307 of FIG. 3 to be applied to the dollar cost estimates corresponding to the predictor variables in the calculation of Raw Value Delivered in step 1403 of FIG. 14. These are example default weights that could be generated in step 307 of FIG. 3.

FIG. 12b shows another exemplary table of categorizations of attributes received and stored in step 303 of FIG. 3 in a database 130 according to one embodiment. In this table, attributes in the database 130 have been categorized as containing searchable text and has having weights. The information in FIG. 12b is used to calculate the Search Grade in step 1422 of FIG. 14. For example, a match of a search text in the Name attribute of an entity would be 3 times as important as a match to the Source 1 User Comments attribute due to their relative weights.

FIG. 12c shows yet another exemplary table of categorizations of attributes received and stored in step 303 of FIG. 3 in a database 130 according to one embodiment. In this table, the example attributes in the database 130 that have been categorized as per step 303 as being style attributes, and descriptions of the meaning of low and high values for those fields. For example, the attribute Noise Level is categorized as a style attribute, with low values meaning “Quiet” and high values meaning “Loud”. Further details regarding style attributes and their use in the calculation of the Style Grade 1423 are provided with reference to step 1410 of the process of FIG. 14. and by equations 15 and 16.

FIG. 13 shows a table of default values for user preferences that is added to a database 130 prior to receipt of user preferences according to one embodiment. In other words, the example table of FIG. 13 would have been generated as part of step 201 of FIG. 2 and the last step 312 of FIG. 3. The first column, Mood, lists all of the moods that a user 106 can select from the dropdown menu in FIG. 9. These moods are also the same as in FIG. 11, which is an expanded view of the dropdown menu for moods according to one embodiment. The remaining columns are default values for each of the user preferences that have been determined in advance and added the database 130. Web server 134 includes these values in the coding for the webpage such as, for example, the form in FIG. 9. Accordingly, when a user 106 selects a mood from the dropdown list, the form automatically updates all of the user preferences to the default values for that mood. This provides the user 106 with a beneficial starting point for selecting preferences according to the user's 106 mood. An examination of the values for the various moods reveals how this structure is capable of capturing with a single user 106 choice of mood a broad range of specifications. The default values as well as the names of the moods for are selected by the programmer based on the programmer's idea of how the individual user preferences might fit well for certain types of users interests. To be clear, this is just one embodiment of default values for an example set of moods. In other embodiments, moods could be named differently and have an entirely different set of default values corresponding to whatever user preferences the programmer decides are relevant to the type of entity to which the system relates. The reasoning behind the values that appear in the Romantic, Special Occasion row of FIG. 13 is explained, as one example, with reference to the embodiment of FIG. 17. As a further example, consider three moods related by inclusion of the term “Foodie” in the name. These are Foodie, Foodie on a Budget, and Foodie, Special Occasion. All of these moods have the Food Weight column set to 3, because Foodie is intended for a user 106 who is particularly interested in the quality of the food at a restaurant. The values for Reliability Importance and Critic Weight are also set slightly higher than the Neutral setting of 1.0. The difference between the three moods is expressed in the first six columns. The Minimum Cost and Maximum Cost columns and Cost/Value Importance columns all vary accordingly. A user 106 selecting Foodie on a Budget is intended to be willing to spend less overall and be more value conscious. Foodie on a Budget is also willing to consider Fast Food as an option. Foodie, Special Occasion has a lower value for Location Importance, as a user 106 seeking to celebrate a special occasion is likely to be willing to travel farther afield to find a special restaurant. In one embodiment, choosing a particular mood from the dropdown list automatically posts the user preferences to data processing system 120. In another embodiment, choosing a particular mood simply sets the user 106 preferences to default values but allows the user 106 to further optimize the user preferences to the user's 106 liking before submitting the form.

FIG. 14 shows a process of generating analytics (step 203 of FIG. 2) in response to a receipt of user preferences according to one embodiment. It should be assumed when reviewing the flowchart in FIG. 14 that the database 130 has already been modified as per the process in the embodiment of FIG. 3 and that the user preferences shown in the form of FIG. 9 have already been received by data processing system 120.

FIG. 14 is organized such that the flowchart on the left side with the vertical solid lines shows the steps in the process. Some of these steps are connected via dashed horizontal lines to the analytics calculated in the connected step. Finally, additional solid lines between the analytics indicate which analytics are used in calculating subsequent analytics as is described in each step of FIG. 14. The calculated analytics on the right of the flowchart in FIG. 14 correlate directly to columns shown in the example table of results of FIG. 10 with the same names. Accordingly, the values of these analytics are form part of the results sent to the user in step 205 of FIG. 2.

In step 1402, entities in the database 130 are filtered based on specific user preferences. The user preferences used for filtration of entities were discussed with reference to the embodiment of FIG. 9. These user preferences are shown in FIG. 9 as the Location text box, Restaurant/Fast Food drop down menu, Takes Online Reservations check box, and the range slider for dollar cost. The user preference for location can be used to filter entities in different ways. For example, the process of FIG. 14 will return sensible results if all entities no matter how distant from the user preference in the Location text box of FIG. 9 are considered, because unless the Location Importance is set to zero, far-distant entities will have much lower Priority Grade 1428 (the Priority Grade 1428 is used to order the entities for search results) and will not appear in the results regardless of user preference in the Location text box. In another embodiment, filtration of entities beyond a reasonable distance can be used for computational efficiency but is not strictly necessary. In another embodiment, the user is offered a means (e.g. menu, checkboxes, etc.) of selecting a subset of entities (corresponding to a neighborhood, city, region, country, etc.) that is used to filter results.

In step 1402A, the user preferences for Rating Type Controls, Source Controls, and Source of Ratings are translated into dollar cost estimate weights. In one embodiment, the values received for these three user preferences are used to determine dollar cost estimate weights as per the process described with reference to the embodiment of FIG. 15. Dollar Cost Estimate Weights are used in equations relating to analytics to weight dollar cost estimates relative to one another. As discussed above with reference to the embodiment of FIG. 9, the user preference for Source of Ratings is used as a filter for dollar cost estimates. This filtration, according to one embodiment, is accomplished by setting weights for dollar cost estimates associated with de-selected user preferences for Source of Ratings to zero, insuring that they are not included in the calculation of any analytics.

FIG. 15 shows a flowchart for the process of translating user preferences into dollar cost estimate weights for different dollar cost estimates according to one embodiment. In step 1 of FIG. 15 default prediction weights are retrieved from the database 130. The default weights were determined earlier as shown in FIG. 3. Each of steps 1502 through step 1504 of FIG. 15 utilize certain sets of user preferences received in step 1 of FIG. 14, which are preferences for Rating Type, Source Type, and Source. In step 1502, user preferences for Rating Type are applied to the default weights. This is accomplished by simply multiplying the preference for each rating type by the dollar cost estimates in the category of each rating type. For example, if the user's preference for the Rating Type, Food, was a 2, then the default weights for the dollar cost estimates predicted from predictor variables such as Source 1 Food and Source 5 Bib in FIG. 12a would be multiplied by a factor of 2, because each of those predictors had previously been categorized the Rating Type food in the database 130. Step 1503 involves applying the user preferences for Source Types to the weights resulting from step 1502 in the same manner. In step 1504 weights associated with de-selected sources are set to zero. For example, consider a dollar cost estimate based on the predictor attribute Source 1 Decor, as shown in the first row of FIG. 12a. The default weight for this dollar cost estimate is 1. The Rating Type is “Atmosphere” and the Source Type is “Verified”. A search performed using the mood “Romantic” as seen in FIG. 13 would cause the dollar cost estimate weight to be set to 2, which is the product of the default weight of 1 from FIG. 12a, the Rating Type Atmosphere value of 2 seen in for this row in FIG. 13, and the Source Verified value of 1 seen for this row in FIG. 13. However, if the checkbox for Zagat were deselected, the weight used would be zero.

Turning back to FIG. 14, in step 1403, the dollar cost estimate weights calculated in step 1402A are used to calculate Raw Value Delivered 1431 for all entities remaining after filtration. Raw Value Delivered 1431 is intended to represent a prediction of value expressed in dollars that is generated by combining dollar cost estimates taking into account the user preferences used in calculating dollar cost estimate weights.

In one embodiment, Raw Value Delivered 1431 is calculated using dollar cost estimate weights for each entity:

$$Raw Value Delivered = \frac{{\sum }_{i} dollar cost {estimate}_{i} * dollar cost estimate {weight}_{i}}{{\sum }_{i} dollar cost estimate {weight}_{i}} \qquad ( 8 )$$

In another embodiment, the entry reliability of the dollar cost estimates weights are incorporated as follows:

$$Raw Value {Delivered}_{j} = \frac{\begin{matrix}{\sum }_{i} dollar cost {estimate}_{i} * \\ {reliability}_{ij} * dollar cost estimate {weight}_{i}\end{matrix}}{{\sum }_{i} dollar cost {estimate }_{i} * {reliability}_{ij}} \qquad ( 8 A )$$

where Raw Value Delivered 1431 for each entity j is calculated using reliabilityᵢⱼ, defined as the reliability of dollar cost estimate i for entity j. As discussed above with reference to FIG. 9, according to one embodiment, only those dollar cost estimates associated a the user preferences for Source of Ratings with their check box checked are used in equations 8 and 8A to calculate Raw Value Delivered 1431.

In other embodiments, Raw Value Delivered 1431 can be calculated using variations of a simple weighted average. In general Raw Value Delivered 1431 can be any monotonically increasing function of the dollar cost estimates whose image is bounded by the range of the estimates themselves. In other words, Raw Value Delivered 1431 can be no higher than the highest dollar cost estimate, and no lower than the lowest dollar cost estimate. The dollar cost estimate weights can be determined from the user preferences by the process shown in FIG. 15. In FIG. 10, the column Raw Value Delivered 1431 shows a dollar-denominated value that corresponds to the system's estimate of the cost of the restaurant based on all dollar cost estimates relevant to the user 106 search taking into account the user preferences as to how such information should be weighted. Note that if the user 106 unchecked boxes for certain Source of Ratings such as Zagats, dollar cost estimates resulting from data obtained from Zagats would not be used in the calculation of Raw Value Delivered 1431. Raw Value Delivered 1431 is used as a comparison to Cost to show the user 106 a measure of value of the restaurant as opposed to the Cost.

As shown in the process of FIG. 14, Raw Value Delivered 1431 is used in the calculation of several other analytics, either directly or through a chain of calculations in which an analytic is based on prior analytics which ultimately depend on Raw Value Delivered 1431. These analytics include Raw Grade 1418, Net Value 1432, Cost-Aware Grade 1419, Suitability Grade 1426, and Priority Grade 1428. This means that each of these listed analytics are dependent on the dollar cost estimates used in the calculation of Raw Value Delivered 1431 and the dollar cost estimate weights derived from the user preferences. Thus, the values for each of these analytics are also dependent on the process of forming the database 130 as described with reference to the embodiment of FIG. 3.

Next, in step 1403A, Raw Value Delivered 1431 is converted to the Raw Grade 1418, which has values in a suitable range (e.g. 0-100). In this and all subsequent steps, it is to be understood that a “Grade” is defined as the output of a monotonically increasing function whose image is the desired range on a domain of all possible inputs (in equations, Grade( ) refers to such a function). Conversion to a Grade, such as that from Raw Value Delivered 1431 to Raw Grade 1418, is accomplished by many methods, such as linear and non-linear transformations, with the aim being to represent the small subset of entities to be actively presented to the user 106 with a range of values that effectively illuminate their relative desirability. The following code, entitled “scale.to.grade”, is one embodiment of a transformation (in this case, a part-wise linear transformation) of input values (the vector x) from an arbitrary scale into one that matches an intuitive set of grades from 0 to 100. Variables mx, lx, dx, etc., shown in the code store intermediate variables.

$$scale . to . grade \\ function ( x , top = 100 , bottom = 0 , \\ mid = 70 , digits = 0 , lim . sd = 3 ) \\ \{ \\ \# scale x to to take on values between top and bottom , \\ \# with the mean falling at mid \\ \# scale above mean and below mean separately \\ \# cap extreme values of x at ( 3 ) standard deviations \\ x < \text{-} cap . sd ( x , lim . sd ) \\ mx < \text{-} mean ( x ) \\ lx < \text{-} min ( x ) \\ hx < \text{-} max ( x ) \\ doh < \text{-} top \text{-} mid \\ dxh < \text{-} hx \text{-} mx \\ dol < \text{-} mid \text{-} bottom \\ dxl < \text{-} mx \text{-} lx \\ out < \text{-} x \\ i . h < \text{-} which ( x > mx ) \\ i . l < \text{-} which ( x <= mx ) \\ \# scale the output that is \\ above the mean to fit from mid to high out [ i . h ] < \text{-} mid + {doh}^{*} ( x [ i . h ] \text{-} mx ) \text{/} dxh \\ \# scale the output that is \\ below the mean to fit from bottom to mid out [ i . l ] < \text{-} mid - {dol}^{*} ( mx \text{-} x [ i . l ] ) \text{/} dxl \\ return ( out ) \\ \} \qquad ( 9 )$$

As an example of the results of this scaling process, row A of FIG. 10 has a Raw Grade of 77 based on a Raw Value Delivered of $37, while row E has a Raw Grade of 79 based on the slightly higher Raw Value Delivered of $38. Raw Grade 1418, therefore, is a means of showing the user 106 the quality of each restaurant, without consideration of price or location.

In step 1404, Net Value 1432 is calculated by subtracting the cost of each entity, as per the equation:

Net Value=Raw Value Delivered−Cost (10)

Net Value 1432 therefore is another measure of value used to inform the user 106 as to the benefit of selecting a specific entity. In row A of the table in FIG. 10, the Raw Value Delivered for the restaurant Republic is $37, whereas the Cost is $27, resulting in a Net Value of $10. This is intended to indicate to the user 106 that, based on the user preferences, for a cost of $27, the user 106 will be getting an extra $10 in value by choosing this restaurant.

In step 1406, the Cost-Aware Grade 1419 is derived from Raw Value Delivered 1431, using a cost-sensitivity user preference, shown as Cost/Value Importance in FIG. 9. In one embodiment, the following equation is used to calculate Cost-Aware Grade 1419 using the cost of each entity, where cost sensitivity is a scalar chosen by the user 106. This calculation is both intuitive and linear.

$$Cost Aware Grade = Grade ( Raw Value Delivered - cost sensitivity * Cost ) \qquad ( 11 )$$

In another embodiment, Cost Aware Grade 1419 can be generalized as

$$Cost Aware Grade = Grade ( Raw Value Delivered - f ( cost sensitivity , Cost ) ) \qquad ( 12 )$$

where f(x,y) is any function that is monotonically increasing with respect to both x and y. The Cost-Aware Grade 1419 takes Cost into account, with more expensive restaurants being penalized relative to less-expensive ones. As a result, the Cost-Aware Grade for row A of FIG. 10 is 91 compared to 86 for row E as a result of the higher cost ($32 vs. $27) for row E. The Cost Aware Grade 1419, therefore, is a means of showing the user 106 how the value of entities compare based their preference for Cost/Value Importance. If the user's preference for Cost/Value Importance was lower in the search that generated the results in FIG. 10, the difference in values of the Cost-Aware Grade for row A and row E would be smaller.

In step 1407, a Reliability Grade 1420 is calculated using information previously stored in the database 130, as discussed above in reference to FIG. 3. Reliability Grade 1420 is defined in an embodiment as:

$$Reliability Grade = Grade ( Record Reliability * \frac{ \begin{matrix}{\sum }_{i} dollar cost estimate {reliability}_{i} * \\ dollar cost estimate {weight}_{i}\end{matrix}}{{\sum }_{i} dollar cost estimate {weight}_{i}} ) \qquad ( 13 )$$

The formula given above can be generalized using a monotonically increasing function of record reliability and dollar cost estimate reliability. Reliability Grade 1420 is calculated as a measure of the amount and accuracy of information about the various entities and is intended to provide user 106 with an idea of how trustworthy the analytics are for each entity. For example, Row A in FIG. 10 has a relatively good Reliability Grade of 85, because of the Number of Reviews contributing to the information in that row is high at 2532 and because the Number of Sources is 3, which is also high. Row D, on the other hand, has a reliability of only 59, because it is based on 49 reviews from only 1 source. Reliability Grade 1420 is intended to indicate to the user the trustworthiness of the information (such as ratings, and other descriptive information such as location, phone number, hours, etc). For example, a restaurant might have a low Reliability Grade 1420 (perhaps because there are only a few reviews, from a low number of sources) where the user preference Reliability Importance in FIG. 9 was set to a low number, but not appear if it was set to a higher number. The user preference Reliability Importance in FIG. 9 controls how heavily the Reliability Grade 1420 is factored into the Suitability Grade 1426 and Priority Grade 1428, as discussed below.

In step 1409, the Search Grade 1422 is calculated by applying some form of fuzzy text search based on text entered in a search box (see, for example, the search box described with reference to FIG. 9) to a plurality of textual attributes in the database 130. In this context, “fuzzy text search” refers to any process that returns a continuous measure of how close the search string is to the data in a given field. A more detailed discussion of fuzzy text search is described in U.S. patent application Ser. No. 14/592,449. The Search Grade 1422 for an entity is typically made up of a weighted average of the Search Grade for individual attributes (i.e. fields in the database describing the entity, such as Name, Description, Comments, etc). The following code is an example of a method for generating a Search Grade value for an individual attribute:

$$scount < \text{-} number . of . occurences ( search . string ) \\ \# cap occurences at 5 \\ scount [ scount > 5 ] < \text{-} 5 \\ \# make sure that rows with \\ no match at all get extra penalty \\ scount [ scount == 0 ] < \text{--} \\ search . fail . {mult}^{*} search . cap . weight \\ \# get scaled distance \\ search . dist < \text{-} ( search . cap . weight \text{-} scount ) \text{/} \\ search . cap . weight \\ \# penalty is in units of standard deviation \\ search . penalty < \text{-} search . {dist}^{*} mult . {search}^{*} p . sort . sd \\ \# turn into a grade \\ search . grade < \text{-} scale . to . grade ( \text{-} search . penalty ) \qquad ( 14 )$$

One skilled in the art will recognize that other variations on this code exist that would also accomplish the aim of quantifying the Search Grade 1422. For example, individual attributes utilized in the process could each be given a weight so that, for example, matches for a field for the entity name, such as Name in FIG. 12b, might be weighted more than those for an attribute with textual user comments, such as Source 1 User Comments in FIG. 12b. Various text-searching techniques could be added, such as allowing inexact matches to handle misspellings, etc., and Natural Language Processing to understand dissimilar text strings that have similar meanings as words. The Search Grade 1422 is meant to indicate to the user 106 how reliably the resulting entities match the search term. For example, if the user 106 entered “Sushi” and that word appeared both in the name of the restaurant and several times in textual ratings, it would get a high Search Grade 1422 informing the user 106 that this is very likely a sushi restaurant. If the word “Sushi” only appeared in the textual ratings and not the name, the Search Grade 1422 would be relatively lower indicating that the probability that the restaurant serves sushi is less likely. The Search Grade in in FIG. 10 is missing (given a value of “NA”), because no text was entered in the search text box. Despite this, the user 106 is still presented with results based on the user's 106 other preference selections.

In step 1410, the Style Grade 1423 is calculated by measuring how closely the values for each entity's attributes match the user preferences for various defined styles. A “style” is defined as a property of an entity which falls upon an axis as opposed to being unidirectional in terms of there being a universal preference for all users 106. For example, the user preference shown in FIG. 9 as a slider labeled “Quiet” or “Loud” is a style preference, because users 106 would not have a unidirectional preference for the level of noise in a restaurant. Some users 106 may prefer a restaurant that is quiet and some may prefer a restaurant that is loud. To compute a style grade, a plurality of numerical style attributes (such as those described with reference to the example in FIG. 12C that are identified in step 303) are retrieved from the database 130 and the user preferences for style direction (e.g. “Quiet” versus “Loud” in FIG. 9) and style weight (e.g., “Noise Level Importance” in FIG. 9) are applied to each entity using the following method. Accordingly, “Style Preferred Value” in equation 15 below is defined as the preferred value of the attribute, e.g., a preference for a restaurant that is quiet or loud, or somewhere in between, and “Style Attribute Weight” in equation 15 below is a scalar defining how important that attribute is. Numerical values can be assigned to these variables based on user preferences shown in the example of FIG. 9. In FIG. 9, the Style Preferred Value in equation 15 is derived from the user's 106 preference for a “Quiet” or “Loud” restaurant, to be a numerical value describing a restaurant, with 0 indicating very quiet and 1 meaning very loud. In FIG. 13, default values for Noise Level Weight and Noise Level Preference are shown for each mood. These values would be those used for the Style Attribute Weight and Style Preferred Value in equation 15 respectively in the event that a user selected a specific mood. For example, the Neutral mood has a Noise Level Weight of 0, indicating that Noise Level will not be taken into consideration. The Romantic mood has a Noise Level Weight of 1, with a Noise Level Preference of 0, meaning that quiet restaurants will be strongly preferred. The Foodie mood also prefers quiet restaurants, although this preference is less strong. The Fast Food mood has a mild preference for loud restaurants. A formula for calculating a Style Grade is:

$$Style Grade = Grade ( \frac{\begin{matrix}{\sum }_{i} f ( Style {Attribute}_{i} - Style Preferred {Value}_{i} ) * \\ Style Attribute {Weight}_{i}\end{matrix}}{{\sum }_{i} Style Attribute {Weight}_{i}} ) \qquad ( 15 )$$

where f(x) is a monotonically increasing function of abs(x), e.g. abs(x) or x². The equation for Style Grade 1423 can be generalized in the same manner as Raw Value Delivered 1431.

In step 1413, the Suitability Grade 1426 is calculated using the Cost-Aware Grade 1419, the Reliability Grade 1420, the Search Grade 1422, the Style Grade 1423, the user preference for Reliability Importance, the user preference for Search Importance, and the user preference for Style Importance as follows:

$$Suitability Grade = Grade ( Cost Aware Grade * Reliability {Grade}^{Reliability Importance} + Search Importance * Search . Grade + Style Importance * Style Grade ) \qquad ( 16 )$$

This can be generalized by replacing Reliability Grade^{Reliability Importance} with any function that is monotonically increasing with respect to Reliability Grade and monotonically decreasing with respect to the user preference for Reliability Importance.

In step 1414, the Distance 1427 is calculated based on first calculating the physical distance (e.g. in miles) using the location entered by the user 106 and the location of the entities. This distance might be also be measured in the form of time using a service, e.g., the API provided by Google Maps, that can estimate actual transit times between points using various modes of transit. The concept of distance as time could be further extended and abstracted to include shipping times, e.g. when entities being compared are items for sale.

In step 1415, Priority Grade 1428 is calculated, balancing Suitability and Distance:

Priority Grade=Grade(Priority)

Priority=Suitability Grade−(Distance Sensitivity*Distance/Distance Scale) (17)

where Distance Sensitivity is a scalar set according to user preferences, and Distance Scale is an additional (optional) scalar, which can be chosen to make the effect of the Distance Sensitivity consistent across multiple queries. One method of doing this is to set

Distance Scale=D_{N}/K (18)

where D_{N} is the distance of the Nth closet entity to the user 106 location, where N is a value such as 100, and K is the desired number (e.g. 5) of points to penalize the Nth Closest entity when Search Importance is set to 1. The formula for Priority can be generalized as

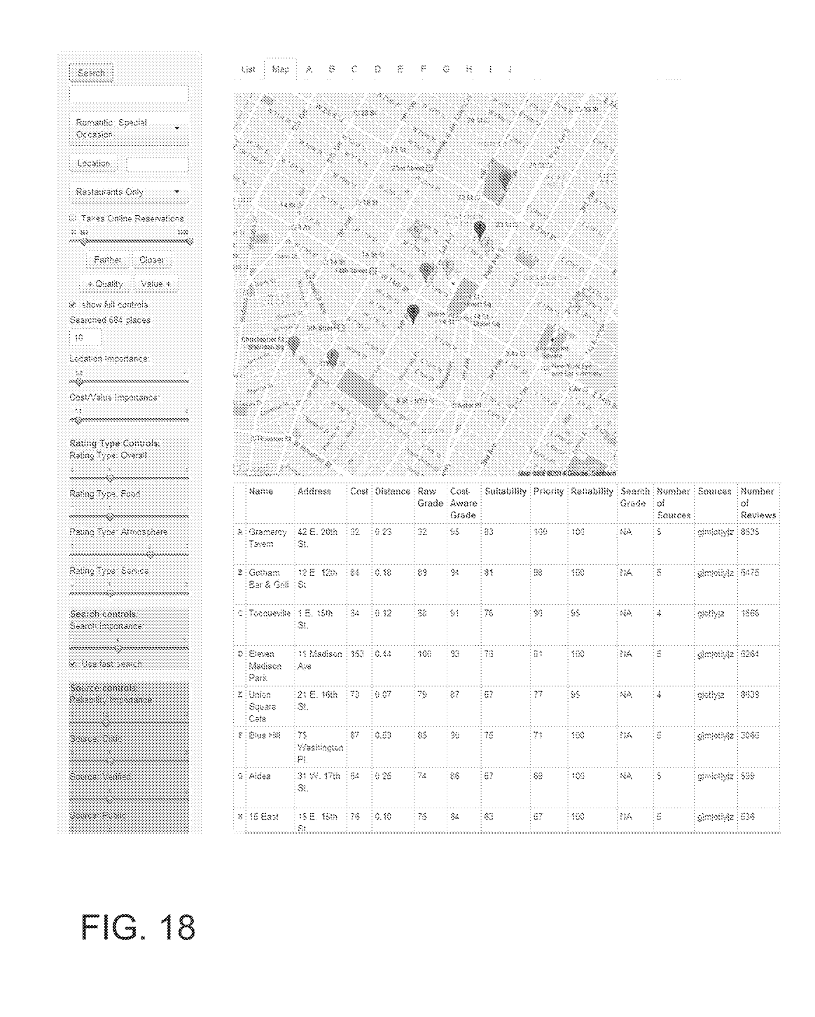

Priority=f(Suitability Grade,Distance Sensitivity,Distance) (19)

where f(Suitability Grade, Distance Sensitivity, Distance) is any function that is monotonically increasing with respect to Suitability and Monotonically Decreasing with respect to Distance Sensitivity and Distance. The Distance sensitivity is controlled by the “Location Importance” slider in FIG. 18. An example of how this control affects the query results is provided with reference to the embodiment of FIG. 18. Priority Grade is the last analytic generated in the process and it is used to order the results. This is shown in each of FIG. 10 and FIG. 16 through FIG. 20 by the fact that the Priority Grade decreases from top to bottom in the results. Priority Grade, therefore, is intended to provide the user 106 with which restaurant is the best choice for the user 106 and the difference in the Priority Grades for each entity shows how close they are relatively to the top choice. The Grade( ) function chosen to calculate Priority Grade from Priority should take into account that since relative distance is unbounded, Priority will generally have a long negative tail, corresponding to distant entities. In order to convert Priority to Priority Grade 1428 as a meaningful value to display to user 106, this tail must be dealt with to avoid a compression effect in which the closest entities all receive the highest possible Priority Grade 1428. The following code accomplishes this by choosing N to calculate a grade relative to only the N highest-priority entities. A reasonable value of N might be 100.

$$N < \text{-} 100 \\ \# cap Priority at value of Nth item \\ cap . value < \text{-} sort ( Priority ) [ N ] \\ Priority [ ( Priority < cap . value ) ] < \text{-} cap . value \\ \# calculate grades now \text{-} \\ long negative tail will all have Grade of 0 \\ Priority . grade < \text{-} scale . to . grade ( Priority ) \qquad ( 20 )$$

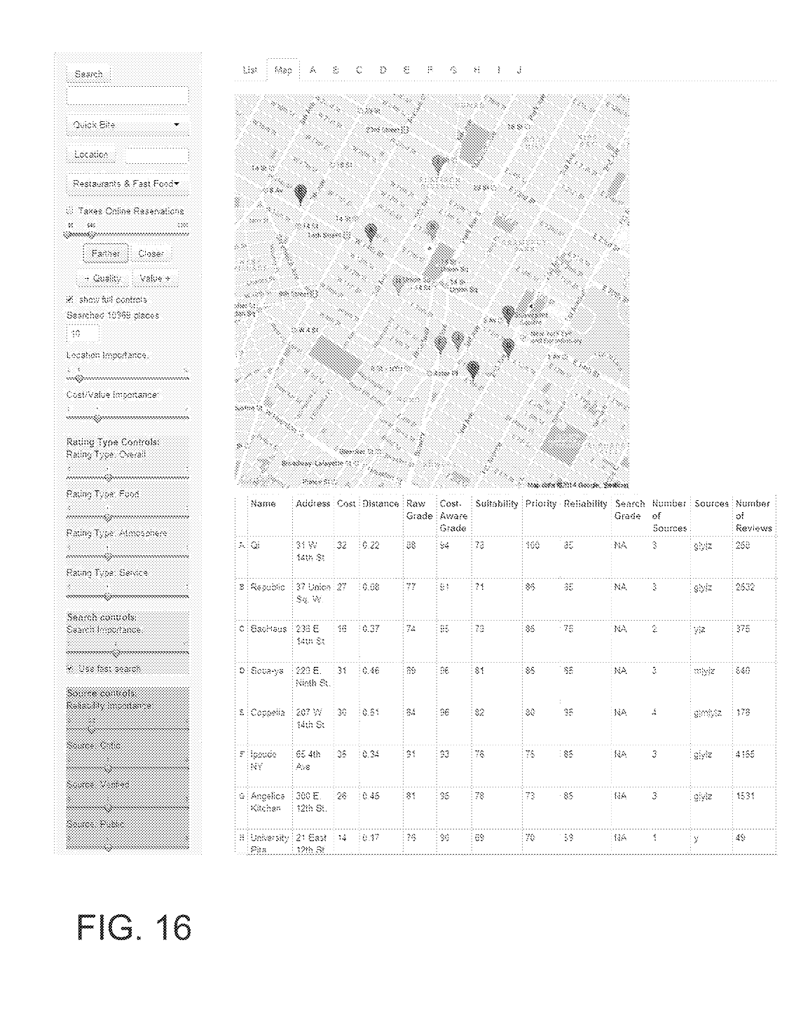

FIG. 16 through FIG. 22 show exemplary webpages useful to explain how the selection of values for particular user preferences impact the results including the analytics sent to the user 106. Note that for the ease of the reader, the form for user preferences (as seen in FIG. 9 earlier) and tabular results (as seen in FIG. 10 earlier) are displayed together in one webpage for each of the examples in FIG. 16 through FIG. 22.

In the example of FIG. 16, the user 106 has changed the value of the Location Importance from 4 (as it was in FIG. 9) to 1. All other parameters are unchanged. Because the Priority values have changed and the entities are ordered based on Priority values, the restaurant Qi, which was row C in FIG. 10 is now row A, and restaurant Republic is below it in row B. The Suitability values for the two restaurants are the same as they were in FIG. 9, but the lower value of Location Importance results in a higher Priority for Qi, as the distance difference between the two restaurants is less important. In general, the Suitability for the restaurants shown in FIG. 16 is higher than that for those in FIG. 10, as it will be observed that the distances are correspondingly greater. This provides the user 106 with a very beneficial means for understanding and controlling the tradeoff between proximity and desirability for an entity, as there is a change in the Priority of the choices presented based on the difference in distance to travel.

In the example of FIG. 17, a different “Mood” than that in FIG. 9 has been selected, in this case, Romantic, Special Occasion. It can be observed that many of the preferences seen in the controls on the left are different between FIGS. 9 and 17 as a result of a different mood being expressed. As would be expected, the resulting set of restaurants is very different in the two cases. For example, the Romantic, Special Occasion restaurants are much more expensive, and spread farther around the city. This is expressed in the Cost slider, which selects restaurants between $60 and $500, but also in the low value of 0.4 for Location Importance and 0.3 for Cost/Value Importance. This expresses the notion that someone looking for a restaurant to celebrate a special occasion is probably willing to travel a bit farther around the city, and is also not as sensitive to Cost/Value. The romantic aspect is expressed in the raised Atmosphere value of 2.

The settings for a particular mood are a starting point. A given user 106 might see the results in FIG. 17, and decide that closer choices are needed. Pressing the Closer button changes the Location Importance from 0.4 to 0.8. The resulting list is shown in the example of FIG. 18. In FIG. 18, all the choices presented are within a much closer radius of the search location. The user 106 has not been asked to determine the search radius (for example, by specifying only restaurants within 1 mile). This is quite beneficial to the user 106, as the system determines the trade-off between Suitability and Distance, rather than requiring the user 106 to do this. It may not be well-known to the user 106 how far afield it is best to look for suitable choices. There may be many suitable choices close by, or there may be very few. An arbitrarily chosen radius may include too many choices or too few.

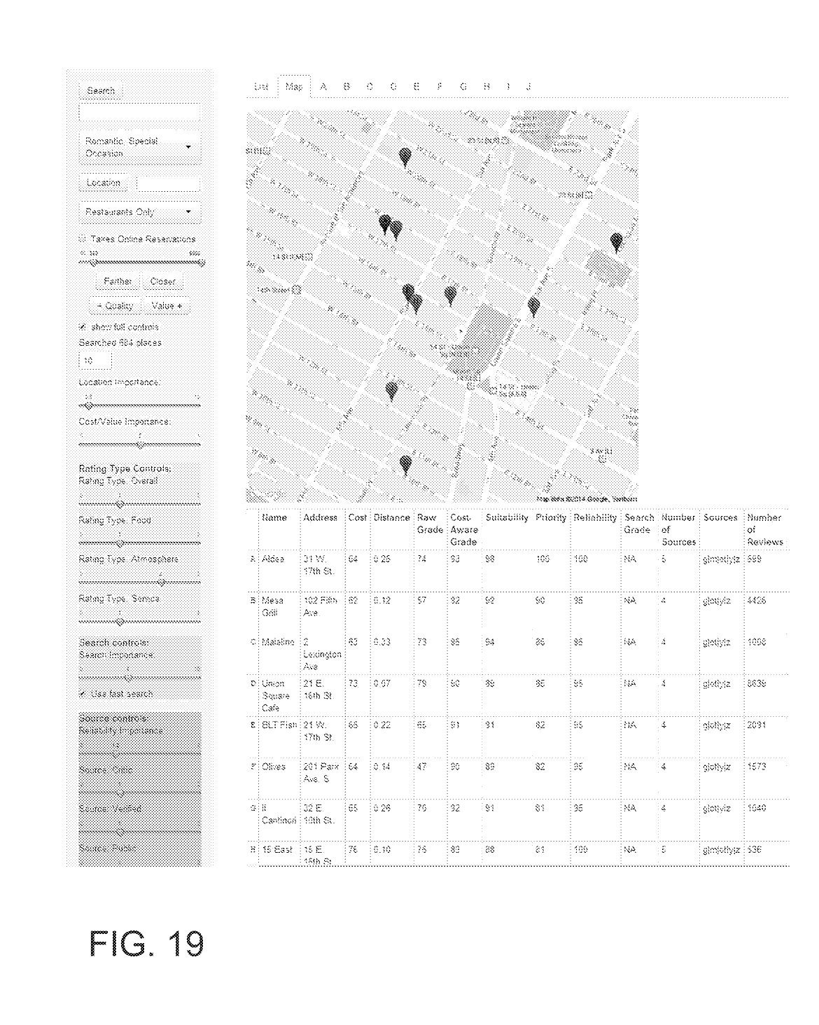

The example of FIG. 19 shows a further interaction with the search results of FIG. 18. In FIG. 19, the user 106 has decided to increase the Cost/Value Importance. This has the effect of prioritizing restaurants that achieve nearly as good ratings as more expensive restaurants. In this example, restaurant Aldea has moved from row G of FIG. 18 to row A of FIG. 19. The Raw Grade of Aldea is 74, rather lower than other restaurants in FIG. 18, but its cost of $64 is also the lowest of the restaurants shown. As a result the Cost-Aware Grade of Aldea is 86 in FIG. 18, when Cost/Value Importance is 0.3. This is enough to place Aldea ahead of restaurant 15 East, which has a higher Raw Grade of 75 but also a higher cost of $76. It is not enough to place Aldea ahead of the restaurant Union Square Café, with a Cost-Aware Grade of 87. In FIG. 19, the higher Cost/Value Importance results in an increased penalty to restaurants with higher costs. Now the Cost-Aware Grade for Aldea is 98, whereas that of Union Square Café is 90. The user 106 has not been asked to choose a lower maximum cost for restaurants, and the system is still considering restaurants costing between $60 and $500, as in FIG. 18. The tradeoff between cost and quality is one that the system is balancing, taking this burden from the user 106. Just as it is generally hard for a user 106 to know how far away suitable choices might be, it is hard for a user 106 to know how much of a difference in quality will result from raising or lowering the amount one is willing to pay. Being presented with the Cost/Value preference is of great value to the user 106.

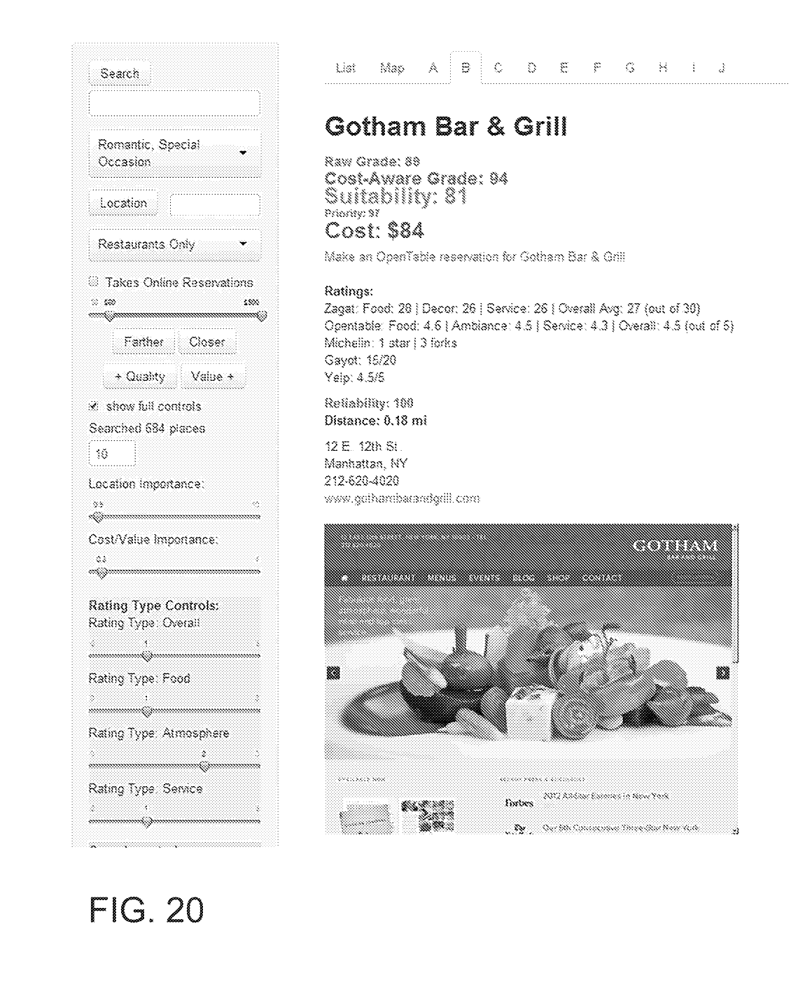

The example of FIG. 20 shows a display of information about a single restaurant, in one embodiment. The information about the restaurant Gotham Bar and Grill that appears in row B of FIG. 18 is now shown together, as well as supplemental information. In particular, the individual ratings from five different sources are displayed.

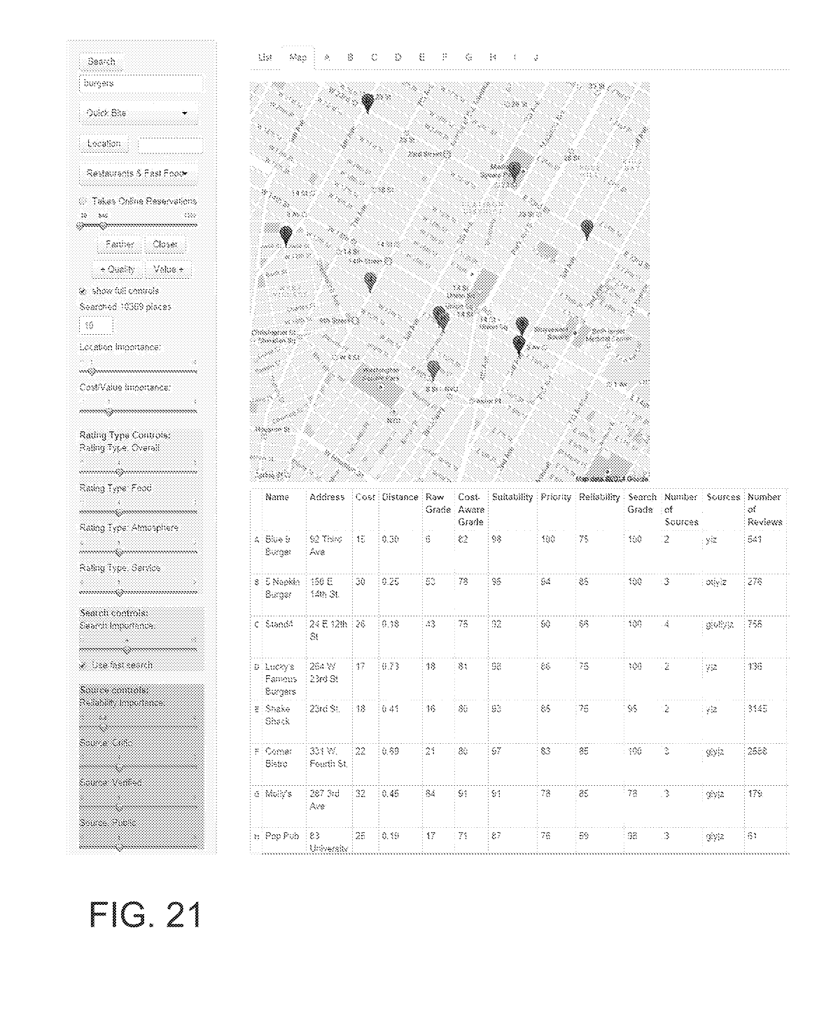

In the example of FIG. 21, a variation of the query of FIG. 16 is shown. In FIG. 21, the user 106 has entered the term “burgers” in the search box. The column Search Grade now displays how well entities match the search text “burgers”. It can be observed that some of the restaurants (e.g. those in rows A through D) have “burgers” in their Name or Website columns. Other restaurants (e.g. Shake Shack) have a high Search Grade despite not having any matches in the columns shown, as the database 130 contains other textual attributes that are not displayed such as, for example, those with the text of a menu, a textual description of a restaurant, or textual comments, etc., that mention the text “burgers”. The Search Importance is controlled by the slider “Search Importance” on the left of FIG. 21, which is set to the value 4.0.

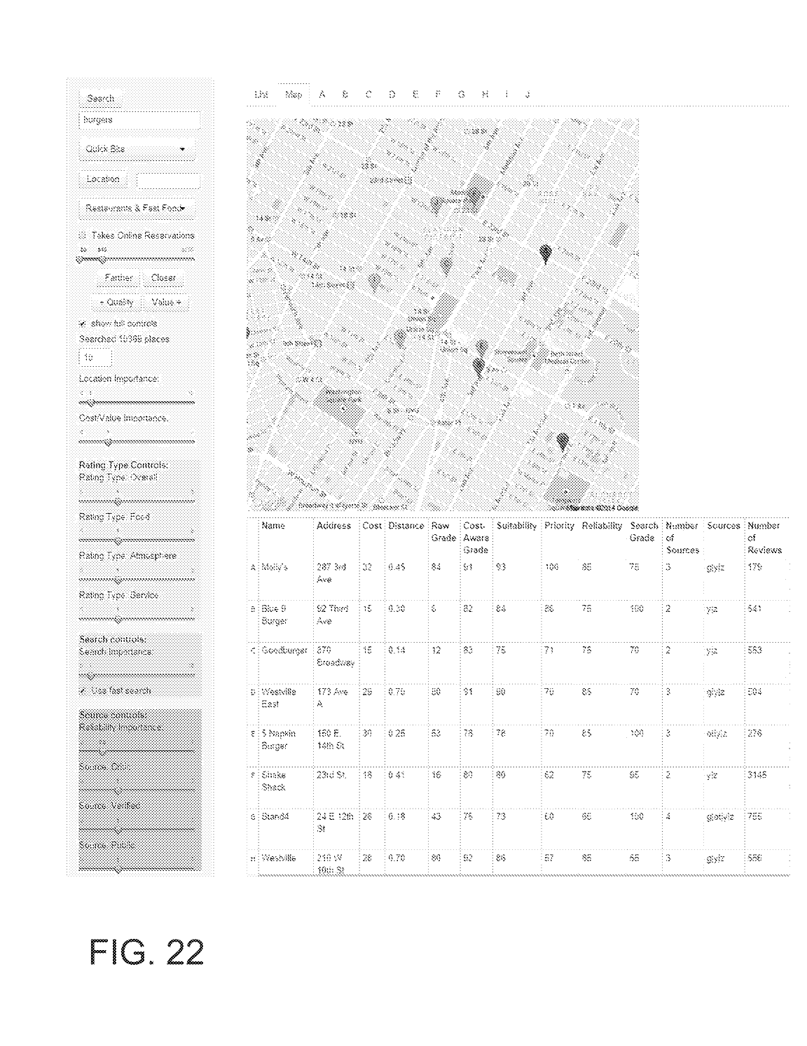

The example of FIG. 22 shows the same query as that in FIG. 21 with Search Importance lowered from 4.0 to 1.0. Now there are more results that have lower values for the Search Grade. For example, Molly's, with a Search Grade of 78, appears in row G of FIG. 21 but appears as the top choice in Row A of FIG. 22. Suitability Grade includes all the information about the restaurant, except for the distance from the user 106. In the example here, restaurant Qi in row C has the highest Suitability Grade of 78, whereas Republic in row A only has a Suitability Grade of 71. Examining the map and the Distance column, it can be seen that Qi is actually the most distant restaurant from the user 106, 0.18 miles away. When the distance is factored in as explained below in calculating the Priority Grade, the result is that Qi receives a lower Priority Grade than Republic, which is only half the distance away.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electro-magnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an 55 erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be executed entirely on the users computer, partly on the users computer, as a standalone software package, partly on the users computer and partly on a remote computer or entirely on the remote computer or server. In the latter scenario, the remote computer may be connected to the users computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system for executing computer software to generate analytics; the system comprising:
a processor;
computer-readable memory coupled to the processor;
a network interface coupled to the processor;
software stored in the computer-readable memory and executable by the processor, the software having;
means for identifying one or more data sources with information about entities;
means for obtaining and storing in a database the information about the entities from the data sources;
means for receiving and storing categorizations of attributes in the database;
means for calculating and storing in the database a cost in dollars for each entity;
means for receiving and storing in the database an identification of some or all attributes as predictor variables;
means for calculating and storing in the database dollar cost estimates for the predictor variables;
means for generating and storing in the database default weights;
means for receiving values for at least one user preference;
means for filtering the database for entities with attributes matching values for at least one user preference;
means for translating default weights and values for at least one user preference into dollar cost estimate weights;
means for calculating Raw Value Delivered; and
means for sending a list of entities with at least one analytic for each entity to users.

2. The system of claim 1, wherein the software further includes:
means for receiving an identification of quality values for each dollar cost estimate and storing the quality values for each dollar cost estimate in the database;
means for calculating and storing in the database reliability values for each dollar cost estimate;
means for receiving an identification of quality values for each record in the database and storing the quality values for each record in the database; and
means for calculating and storing in the database reliability values for each record.

3. The system of claim 1, wherein the software further includes:
means for calculating Raw Grade.

4. The system of claim 1, wherein the software further includes:
means for calculating Net Value.

5. The system of claim 1, wherein the software further includes:
means for calculating Cost-Aware Grade.

6. The system of claim 2, wherein the software further includes:
means for calculating Reliability Grade.

7. The system of claim 1, wherein the software further includes:
means for calculating Search Grade.

8. The system of claim 1, wherein the software further includes:
means for calculating Style Grade.

9. The system of claim 2, wherein the software further includes:
means for calculating Raw Grade.
means for calculating Cost-Aware Grade.
means for calculating Reliability Grade;
means for calculating the Search Grade;
means for calculating the Style Grade;
means for calculating the Suitability Grade.

10. The system of claim 1, wherein the software further includes:
means for calculating Distance.

11. The system of claim 9, wherein the software further includes:
means for calculating Distance.
means for calculating the Priority Grade.

12. A computer implemented method of generating analytics, comprising:
identifying one or more data sources with information about entities;
obtaining and storing in a database the information about the entities from the data sources;
receiving and storing categorizations of attributes in the database;
calculating and storing in the database a cost in dollars for each entity;
receiving and storing in the database an identification of some or all attributes as predictor variables;
calculating and storing in the database dollar cost estimates for the predictor variables;
generating and storing in the database default weights;
receiving values for at least one user preference;
filtering the database for entities with attributes matching values for at least one user preference;
translating default weights and values for at least one user preference into dollar cost estimate weights;
calculating Raw Value Delivered; and
sending a list of entities with at least one analytic for each entity to users.

13. The method of claim 12, further comprising:
receiving an identification of quality values for each dollar cost estimate and storing the quality values for each dollar cost estimate in the database;
calculating and storing in the database reliability values for each dollar cost estimate;
receiving an identification of quality values for each record in the database and storing the quality values for each record in the database; and
calculating and storing in the database reliability values for each record.

14. The method of claim 12, further comprising:
calculating Raw Grade.

15. The method of claim 12, further comprising:
calculating Net Value.

16. The method of claim 12, further comprising:
calculating Cost-Aware Grade.

17. The method of claim 13, further comprising:
calculating Reliability Grade.

18. The method of claim 12, further comprising:
calculating Search Grade.

19. The method of claim 12, further comprising:
calculating Style Grade.

20. The method of claim 13, further comprising:
calculating Raw Grade.
calculating Cost-Aware Grade.
calculating Reliability Grade;
calculating Search Grade;
calculating Style Grade; and
calculating Suitability Grade.

21. The method of claim 12, further comprising:
calculating Distance.

22. The method of claim 20, further comprising:
calculating Distance; and
calculating the Priority Grade.

23. The system of claim 1, further comprising:
means for receiving and storing in the database default values for moods; and
means for sending the option to select a mood to the user.

24. The method of claim 12, further comprising:
receiving and storing in the database default values for moods; and
sending the option to select a mood to the user.

25. A computer readable non-transitory storage medium comprising instructions executable by a processor for:
identifying one or more data sources with information about entities;
obtaining and storing in a database the information about the entities from the data sources;
receiving and storing categorizations of attributes in the database;
calculating and storing in the database a cost in dollars for each entity;
receiving and storing in the database an identification of some or all attributes as predictor variables;
calculating and storing in the database dollar cost estimates for the predictor variables;
generating and storing in the database default weights;
receiving values for at least one user preference;
filtering the database for entities with attributes matching values for at least one user preference;
translating default weights and values for at least one user preference into dollar cost estimate weights;
calculating Raw Value Delivered; and
sending a list of entities with at least one analytic for each entity to users.

26. The computer readable non-transitory storage medium of claim 25, further comprising:
receiving an identification of quality values for each dollar cost estimate and storing the quality values for each dollar cost estimate in the database;
calculating and storing in the database reliability values for each dollar cost estimate;
receiving an identification of quality values for each record in the database and storing the quality values for each record in the database; and
calculating and storing in the database reliability values for each record.

27. The computer readable non-transitory storage medium of claim 25, further comprising:
calculating Raw Grade.

28. The computer readable non-transitory storage medium of claim 25, further comprising:
calculating Net Value.

29. The computer readable non-transitory storage medium of claim 25, further comprising:
calculating Cost-Aware Grade.

30. The computer readable non-transitory storage medium of claim 26, further comprising:
calculating Reliability Grade.

31. The computer readable non-transitory storage medium of claim 25, further comprising:
calculating Search Grade.

32. The computer readable non-transitory storage medium of claim 25, further comprising:
calculating Style Grade.

33. The computer readable non-transitory storage medium of claim 26, further comprising:
calculating Raw Grade.
calculating Cost-Aware Grade.
calculating Reliability Grade;
calculating Search Grade;
calculating Style Grade; and
calculating Suitability Grade.

34. The computer readable non-transitory storage medium of claim 25, further comprising:
calculating Distance.

35. The method of claim 33, further comprising:
calculating Distance; and
calculating the Priority Grade.

36. The computer readable non-transitory storage medium of claim 25, further comprising:
receiving and storing in the database default values for moods; and
sending the option to select a mood to the user.
